(19) United States
(12) Patent Application Publication
(10) Pub. No.: US 2012/0017211 A1
(43) Pub. Date: Jan. 19, 2012

(54) VIRTUAL COMPUTER SYSTEM, INFORMATION PROCESSING DEVICE, STORAGE MEDIUM STORING COMPUTER PROGRAM, AND CONNECTION CONTROL METHOD

(75) Inventors: Takashi Ohno, Kawasaki (JP); Ryuichi Matsukura, Kawasaki (JP)

(73) Assignee: Fujitsu Limited

(21) Appl. No.: 13/240,334

(22) Filed: Sep. 22, 2011

Related U.S. Application Data
(63) Continuation of application No. PCT/JP2009/056637, filed on Mar. 31, 2009.

(51) Int. Cl. G06F 9/455

(52) U.S. Cl. 718/1

(57) ABSTRACT

When physical resources are logically divided to cause the divided resources to operate as plural virtual computers, and when any one or more of virtual machines 4 are assigned a device 3 and enters a controlled state of a control terminal 2, an information processing device 1 performs release of either the device 3 or a remote control from the virtual machines 4.

### CROSS-REFERENCE TO RELATED APPLICATION

This application is a continuation application of International PCT Application No. PCT/JP2009/056637, which was filed on Mar. 31, 2009.

### FIELD

The present embodiments relate to a virtual computer system, information processing device, computer program, and connection control method for performing a remote control to logically divide physical resources and cause the divided resources to act as virtual computers.

### BACKGROUND

In recent years, electronic computers have seen drastic improvements in performance, and for that reason, electronic computers have excess capacity for conventional usages such as document creation, e-mails, and web browsing.

In view of these circumstances, an electronic computer having virtualization functions has been proposed. The virtualization functions abstract physical resources and divide them into plural virtual resources, and have the virtual resources operate as independent virtual machines. An electronic computer having virtualization functions utilizes the extra capacity as plural virtual machines.

As described above, by aggregating the resources of plural electronic computers into a single electronic computer, the virtualization functions can reduce the number of actual machines needed so that the burdens of placement site, power consumption, and maintenance management can be reduced.

Electronic computers have plural types of resources for controlling virtual machines. For example, electronic computers can have plural pieces of input/output equipment such as a keyboard, a mouse, a display device, or a printer device connected through interfaces such as USB (Universal Serial Bus) or HDMI (High-Definition Multimedia Interface). The electronic computers can also be connected to plural external devices through a computer network.

Therefore, electronic computers have a control through input/output equipment and a remote control through external devices as control means for each of the virtual machines.

A device for appropriately switching between plural control methods in a device control of the virtual machines has been proposed (For example, Patent Document 1).

Patent Document 1: Japanese Laid-open Patent Publication No. 2008-146566

However, the proposed device is either a system in which a device is occupied by a virtual machine or a system in which a device is shared by plural virtual machines. These systems are not intended for assigning control resources to more virtual machines.

In other words, electronic computers can set an infinite number of virtual machines by dividing hardware resources having a physical nature. However, the number of pieces of input/output equipment that can be connected to these electronic computers is limited in accordance with the number of ports in interfaces that can be mounted to the electronic computers. It is therefore impossible to assign input/output equipment to all of the virtual machines.

In view of these circumstances, when there is no more input/output equipment, the virtual machines should be controlled by external devices through remote control. In other words, if the input/output equipment or the remote control can be assigned alternatively to each of the virtual machines, a larger number of virtual machines can be operated, and extra capacity can be effectively utilized as virtual machines. However, the proposed device is not intended for the above circumstances.

In addition, there is a problem with the remote control wherein, since the amount of data that can be transferred through a network is limited, operation response is reduced and large-capacity videos cannot be reproduced without dropping frames. On the other hand, input/output equipment does not have such a problem. For that reason, it is desirable to use input/output equipment to control the virtual machines. However, the proposed device does not take such circumstances into account.

### SUMMARY

The disclosed virtual computer system is a virtual computer system, comprising a central unit to logically divide a physical resource and to cause the divided resources to operate as a plurality of virtual computers, and a plurality of terminal devices connectable to the central unit through a communication line; each of the virtual computers includes a receiving means to receive a remote control of the virtual computer itself from any one of the terminal devices, the central device includes an interface connecting to a plurality of input/output equipment, assigning means to assign the connected input/output equipment to each of the virtual computers, and release means to release the controlled computer from either the input/output equipment or the remote control when any one of the virtual computers has input/output equipment assigned to it and becomes a controlled computer controlled by the remote control, and wherein the released input/output equipment can be assigned to another virtual computer different from the controlled computer.

In addition, the disclosed information processing device is an information processing device to logically divide a physical resource and to cause the divided resources to operate as a plurality of virtual computers, comprising receiving means in which each of the virtual computers receives a remote control from an external device connected through a communication line, an interface connecting to a plurality of input/output equipment, assigning means to assign the connected input/output equipment to each of the virtual computers, and release means to release the controlled computer from either the input/output equipment or the remote control when any one of the virtual computers has input/output equipment assigned to it and becomes a controlled computer controlled by the remote control.

Furthermore, the disclosed computer program is a computer program causing a computer to divide a physical resource and causing the divided resources to operate as a plurality of virtual computers, comprising causing each of the virtual machines to receive a remote control of an external device, detecting each of a plurality of pieces of input/output equipment connected to each of the virtual computers, assigning the detected input/output equipment to each of the virtual computers, and releasing, when any one of the virtual computers has input/output equipment assigned to it and becomes a controlled computer controlled by the remote control, the controlled computer from either the input/output equipment or the remote control.

In the disclosed virtual computer system, information processing device, computer program, and connection control method, when physical resources are logically divided to cause the divided resources to operate as plural virtual computers, and when any one or more of the virtual computers have input/output equipment assigned to them and become a controlled computer through a remote control of an external device, the information processing device performs release of the input/output equipment or remote control of the controlled computer.

When physical resources are logically divided to operate as plural virtual computers, the disclosed virtual computer system, information processing device, computer program, and connection control method can prevent a single virtual computer from occupying plural types of control resources so that the control resources can be assigned to more virtual machines.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating the entire configuration of the virtual computer system of Embodiment 1;

FIG. 2 is a block diagram illustrating the configurations of the information processing device and peripheral devices in Embodiment 1;

FIG. 3 is a diagram illustrating the storage content of the auxiliary storage device in Embodiment 1;

FIG. 4 is a functional block diagram of the information processing device of Embodiment 1;

FIG. 5 is a diagram illustrating an example of a format of the device management table;

FIG. 6 is a diagram illustrating an example of a display of the authentication screen;

FIG. 7 is a flowchart illustrating procedures of device release processing executed by the information processing device 1 in Embodiment 1;

FIG. 8 is a functional block diagram of the information processing device in Embodiment 2;

FIG. 9 is a diagram illustrating an example of a display of the release check screen;

FIG. 10 is a flowchart illustrating the procedures of the device release processing that the information processing device executes in Embodiment 2;

FIG. 11 is a functional block diagram of the information processing device in Embodiment 3;

FIG. 12 is a diagram illustrating the storage contents of the auxiliary storage device in Embodiment 3;

FIG. 13 is a flowchart illustrating the procedures of the release waiting declaration processing that the information processing device executes in Embodiment 3;

FIG. 14 is a flowchart illustrating the procedures of the device release processing that the information processing device executes in Embodiment 3;

FIG. 15 is a functional block diagram of the information processing device in Embodiment 4;

FIG. 16 is a diagram illustrating a display example of a release notice;

FIG. 17 is a flowchart illustrating the procedures of the device release processing executed by the information processing device 1 in Embodiment 4;

FIG. 18 is a functional block diagram of the information processing device in Embodiment 5;

FIG. 19 is a diagram illustrating the stored contents of the auxiliary storage device in Embodiment 5;

FIG. 20 is a diagram illustrating an example of the format of the authentication information table;

FIG. 21 is a diagram illustrating an example of the format of the virtual machine management table;

FIG. 22 is a diagram illustrating an example of the format of the device group management table;

FIG. 23 is a flowchart illustrating the procedures of device release processing executed by the information processor device in Embodiment 5;

FIG. 24 is a diagram illustrating the entire configuration of the virtual computer system in Embodiment 6;

FIG. 25 is a block diagram illustrating the configurations of the information processing device and its peripheral devices in Embodiment 6;

FIG. 26 is a functional block diagram of the information processing device and peripheral devices in Embodiment 6;

FIG. 27 is a flowchart illustrating the procedures of the remote control processing executed by the information processing device in Embodiment 6; and

FIG. 28 is a flowchart illustrating the procedures of the device release processing executed by the information processing device in Embodiment 6.

### DESCRIPTION OF EMBODIMENTS

### Embodiment 1

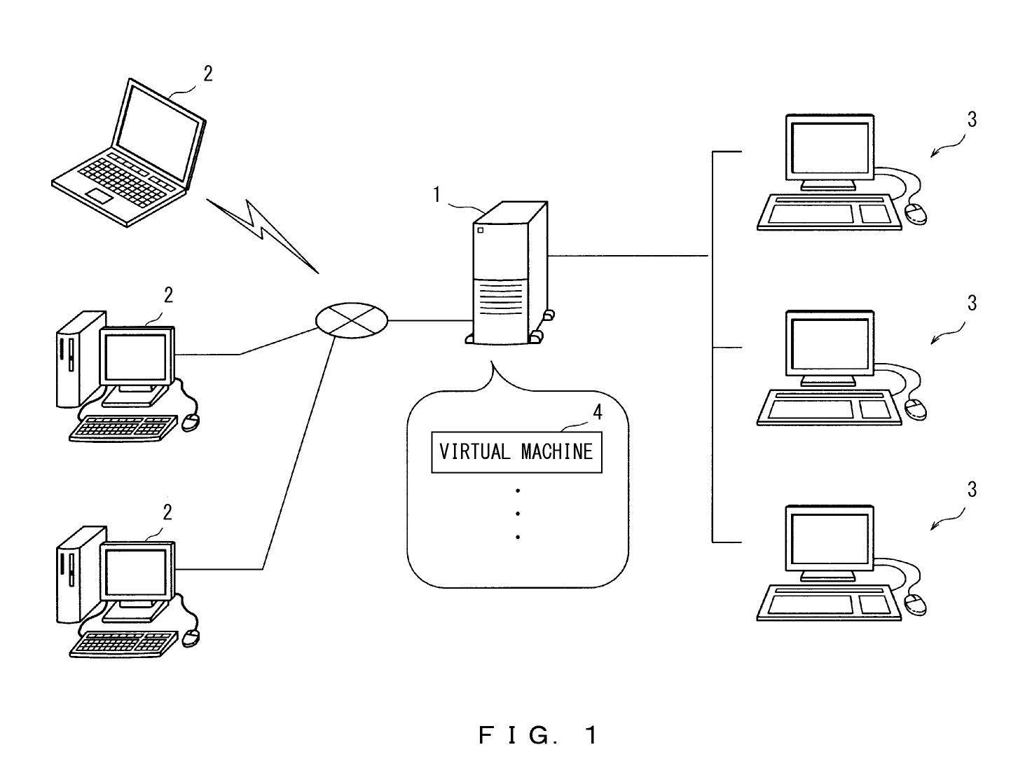

Details of the disclosed virtual computer system, information processing device, computer program, and connection control method are explained on the basis of the drawing illustrating the present embodiment. FIG. 1 is a diagram illustrating the entire configuration of the virtual computer system of Embodiment 1.

An information processing device 1 is a central unit constituting the virtual computer system of the present embodiment. An example of the virtual computer system is a virtual PC thin-client system. The information processing device 1 logically divides hardware resources described later, and runs the hardware resources as plural virtual machines 4.

An example of the information processing device 1 is a versatile electronic computer. The configuration of the information processing device 1 is described later.

A control terminal 2 can be connected to the information processing device 1 over a computer network. The control terminal 2 can be connected to the information processing device 1 through, for example, wired communication or wireless communication. The control terminal 2 is a device for remote control over the virtual machines 4. An example of the control terminal 2 is a personal computer or a laptop computer.

An input/output device (hereinafter referred to as “device”) 3 can be connected to the information processing device 1 through an interface. The device 3 exchanges data with the virtual machines 4. The device 3 is a device for operating the virtual machines 4. An example of the device 3 is an input device such as a keyboard, a mouse, an image scanner device, or a tablet device, and an output device such as a display device or a printer device.

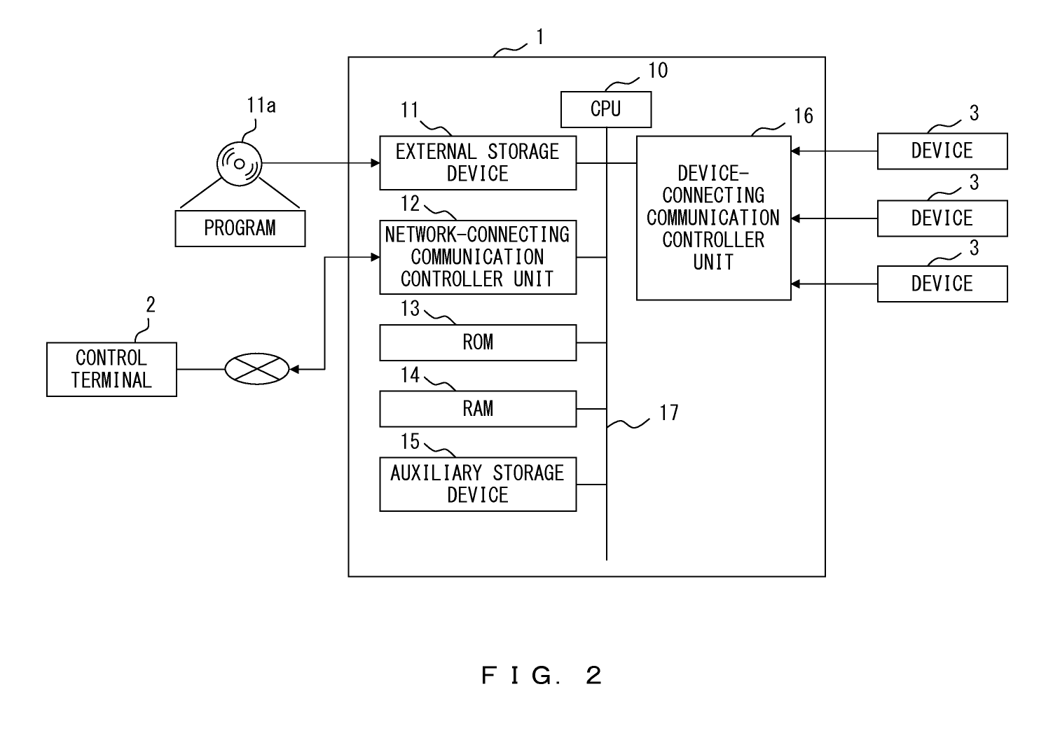

FIG. 2 is a block diagram illustrating the configurations of the information processing device 1 and peripheral devices in Embodiment 1. The information processing device 1 has a CPU 10, an external storage device 11, a network-connecting communication controller unit 12, a ROM 13, a RAM 14, an auxiliary storage device 15, and a device-connecting communication controller unit 16. Respective hardware resources are connected to each other through a bus 17.

The CPU 10 is a resource having a virtualization function and other functions. The CPU 10 performs processing described later and various processing in accordance with an operating system (hereinafter abbreviated as “OS”) and the disclosed computer program. The CPU 10 hides the physical properties of the above-described hardware resources from systems, application software, and end users. The CPU 10 divides the hardware resources into plural virtual resources and runs the virtual resources as plural virtual machines 4. The virtual machines 4 output the control result to the control terminal 2 or the device 3. Other functions are explained later.

The external storage device 11 is a reader/writer for reading or writing data in a storage medium 11a. An example of the reader/writer is a flexible disk drive, an MO drive, a CD-R drive, a magnetic tape drive, a memory card reader/writer, or an interface for attaching and removing a USB memory.

The external storage device 11 has an attachment opening (not illustrated), and the recoding medium 11a is attached when the recording medium 11a is inserted into the attachment opening. The external storage device 11 has the recording medium 11a detached when the recording medium 11a is pulled from the attachment opening. The external storage device 11 outputs a notice of attachment of the recording medium 11a or detachment of the recording medium 11a to the CPU 10.

The recording medium 11a is a type of removable media. Examples of the removable media include a flexible disk, an MO, a CD-R, a magnetic tape, a memory card, or a USB memory. The recording medium 11a stores programs and various data. The programs include an OS, the disclosed computer program, and other application software.

The network-connecting communication controller unit 12 is a resource for receiving the remote control of each control terminal 2 through a computer network. The network-connecting communication controller unit 12 has the Ethernet (registered trademark) standard, for example, as an interface, and performs communication based on TCP/IP. The network-connecting communication controller unit 12 receives a control signal transmitted from the control terminal 2 and outputs the signal to the CPU 10.

The network-connecting communication controller 12 can be connected to a number of control terminals 2 on a computer network by using switching hubs in a multiple-step form. In addition, the network-connecting communication controller unit 12 can receive the remote control of the control terminal 2 placed in the distance over a computer network. Meanwhile, in the network-connecting communication controller unit 12, data transfer capability remains approximately 100 megabits per second (hereinafter referred to as “Mbps”) due to the upper limit of the bandwidth of the computer network.

The ROM 13 is a storage device that enables reading out recorded data. The ROM 13 is a semiconductor device for storing a Basic Input/Output System (hereinafter referred to as BIOS) and other firmware.

The RAM 14 is a resource for temporarily storing data created as a result of execution of the CPU 10 or data read out from the auxiliary storage device 15. The RAM 14 can be a semiconductor such as SDRAM (Synchronous DRAM) or SRAM (Static RAM).

The auxiliary storage device 15 stores data received from the external storage device 11, the RAM 14, or the device 3. A magnetic disk recording hard disk drive (HDD) or flash solid state drive (Flash SSD) constituting NAND elements, for example, serves as the auxiliary storage device 15. The auxiliary storage device 15 maybe placed on another information processing device over a network or a fiber channel.

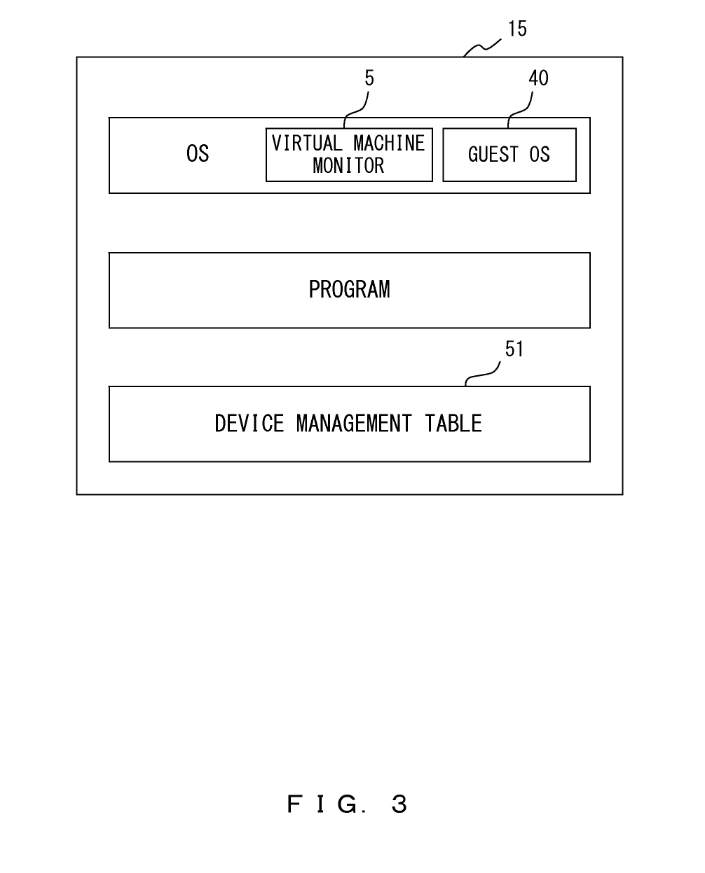

FIG. 3 is a diagram illustrating the storage content of the auxiliary storage device 15 in Embodiment 1. The auxiliary storage device 15 stores an OS and the disclosed computer programs. The OS controls the information processing device 1. The OS, additionally, includes a guest OS 40 for controlling the virtual machines 4 and a virtual machine monitor 5 for controlling the guest OS 40. It should be noted that the configuration of the OS, the guest OS 40, and the virtual machine monitor 5 is not limited to this example. For example, the OS, the guest OS 40 and the virtual machine monitor 5 may be independent components but still operate together. The auxiliary storage device 15 stores a device management table 51 described later.

The device-connecting communication controller unit is a resource for connecting plural devices 3. The device-connecting communication controller unit 16 has a USB standard as an interface, for example, and communicates with the devices 3. The device-connecting communication controller unit 16 receives data transmitted from the device 3 and outputs the data to the CPU 10 or the auxiliary storage device 15.

The device-connecting communication controller unit 16 has a data transfer capability of about 480 Mbps, which exceeds the data transfer capability on a computer network. Meanwhile, the device-connecting communication controller unit 16 can be connected to only a few devices 3 due to limitations in physical space and in throughput and constraints in standards of the information processing device 1. The longest transfer distance of the device-connecting communication controller unit 16 remains about 20 m.

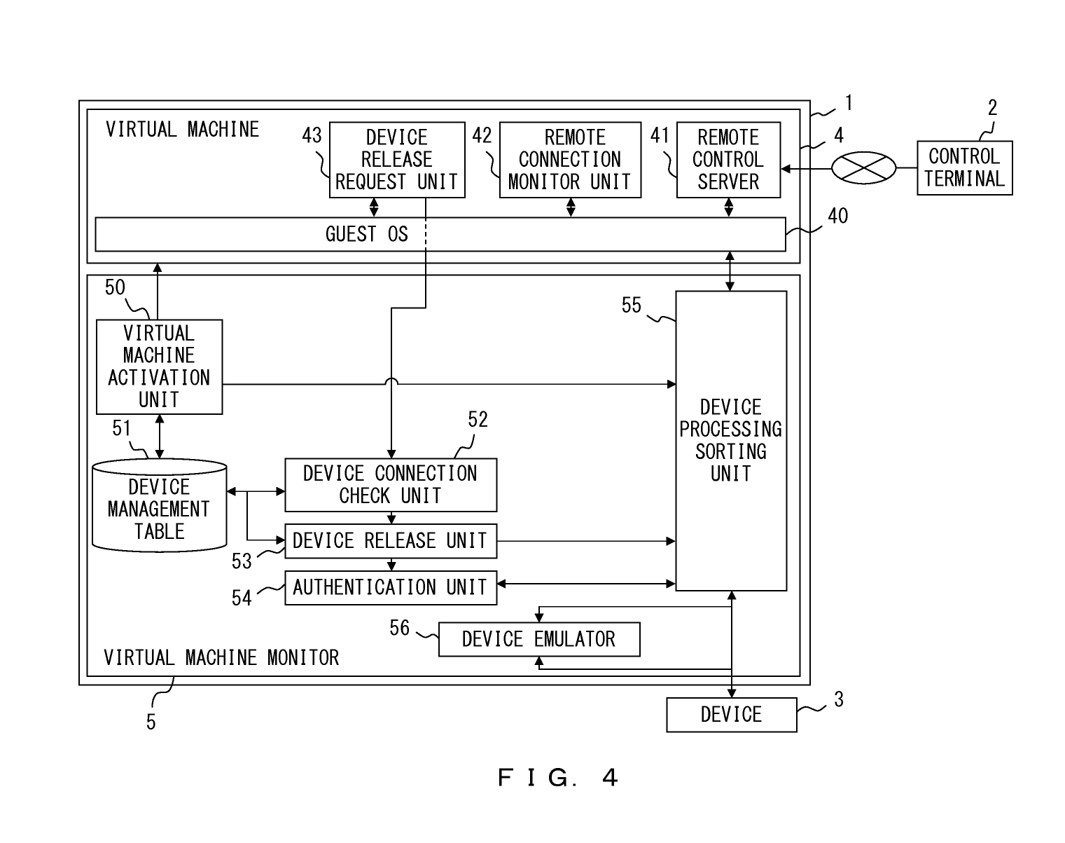

FIG. 4 is a functional block diagram of the information processing device 1 of Embodiment 1. The information processing device 1 has the virtual machines 4 and the virtual machine monitor 5.

The virtual machines 4 are abstractions of the hardware resources of the information processing device 1, and exist in a plural number. Each of the virtual machines 4 has a guest OS 40, a remote control server 41, a remote connection monitor unit 42, and a device release request unit 43.

The guest OS 40 starts up in the virtual machine 4, and controls the virtual resources of the virtual machine 4. The guest OS 40 is installed in the information processing device 1 through the external storage device 11, or the network-connecting communication controller unit 12. The guest OS 40 is stored in the auxiliary storage device 15.

The remote control server 41 receives the remote controls of the control terminal 2 and controls the guest OS 40 in accordance with the received remote controls. The remote control server 41 outputs screen information to be displayed to the control terminal 2. The remote control server 41 is one of the functions of the CPU 10.

The remote connection monitor unit 42 monitors availability of the remote controls of the control terminal 2. The remote connection monitor unit 42 determines that its virtual machine is in a state of being controlled by the remote control when detecting the remote controls of the control terminal 2. When the remote connection monitor unit 42 determines that its virtual machine is in a controlled state, it outputs a request for releasing the devices 3 from the virtual machines 4 to a device release request unit 43. The remote connection monitor unit 42 is one of the functions of the CPU 10. The remote connection monitor unit 42 is controlled by the guest OS 40.

When the device release request unit 43 receives the release request from the remote connection monitor unit 42, it outputs the received request and identification information of its virtual machine to the virtual machine monitor 5. The device release request unit 43 is one of the functions of the CPU 10. The device release request unit 43 is controlled by the guest OS 40.

The virtual machine monitor 5 manages each of the virtual machines 4. The virtual machine monitor 5 is one of the functions of the CPU 10. The virtual machine monitor 5 has a virtual machine starting unit 50, a device management table 51, a device connection check unit 52, a device release unit 53, an authentication unit 54, a device processing sorting unit 55, and a device emulator 56. The virtual machine starting unit 50 starts up arbitrary virtual machines 4.

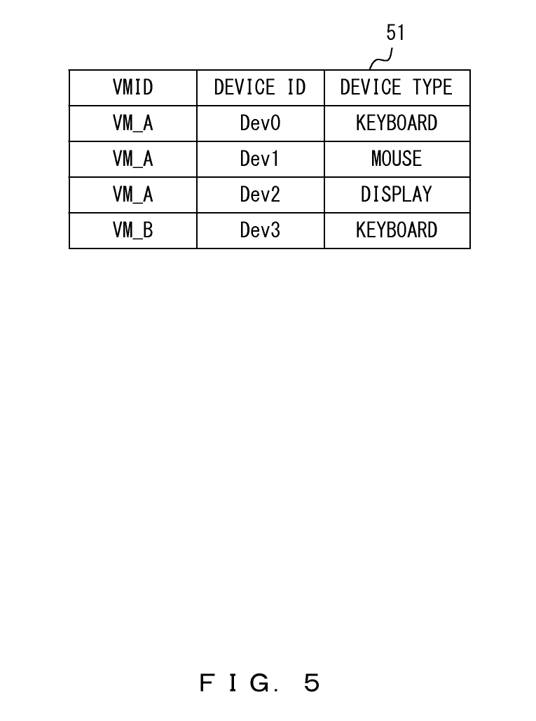

FIG. 5 is a diagram illustrating an example of a format of the device management table 51. The device management table 51 stores associations between an arbitrary one or more of plural devices 3 and an arbitrary one or more of plural virtual machines 4. The device management table 51 associates the identification information of the virtual machines 4 (VMID) with the identification information of the devices 3 (device ID) and the type of the devices 3 (device type) and stores the associations. The identification information of the devices 3 and the type of the devices 3 are generated by the device-connecting controller 16 at the time of starting the information processing device 1 and of connecting the devices 3. The associations are executed by the CPU 10 at the time of starting the virtual machines 4. The devices 3 enter a state of being assigned to the virtual machines 4 as a result of the associations.

The device connection check unit 52 extracts the identification information of the devices 3 corresponding to the virtual machines 4 from the device management table 51 when the request for releasing the devices 3 and the identification information of the virtual machines 4 are received from the device release request unit 43. The identification information of the virtual machines 4 indicates a virtual machine 4 that is requested to release the devices 3. The identification information of the devices 3 indicates a device 3 to be released. The device connection check unit 52 outputs the request for releasing the devices 3, the identification information of the devices 3, and the identification information of the virtual machines 4 to the device release unit 53, when the identification information of the devices 3 can be extracted.

The device release unit 53, when receiving the request for releasing the devices 3, the identification information of the devices 3, and the identification information of the virtual machines 4 from the device connection check unit 52, dissolves the association between the identification information of the devices 3 and the identification information of the virtual machines 4 that are received. As a result, the devices 3 are in a state of being released from the virtual machines 4. Each of the released devices 3 includes input equipment and output equipment. The released devices 3 are controlled by the device processing sorting unit 55. The device release unit 53 deletes corresponding records in the device management table. The device release unit 53 outputs a request for outputting an authentication screen to the authentication unit 54.

The authentication unit 54 outputs the authentication screen on the released devices 3 (output equipment) when receiving the request for outputting an authentication screen from the device release unit 53. The authentication unit 54 performs the authentication processing described later.

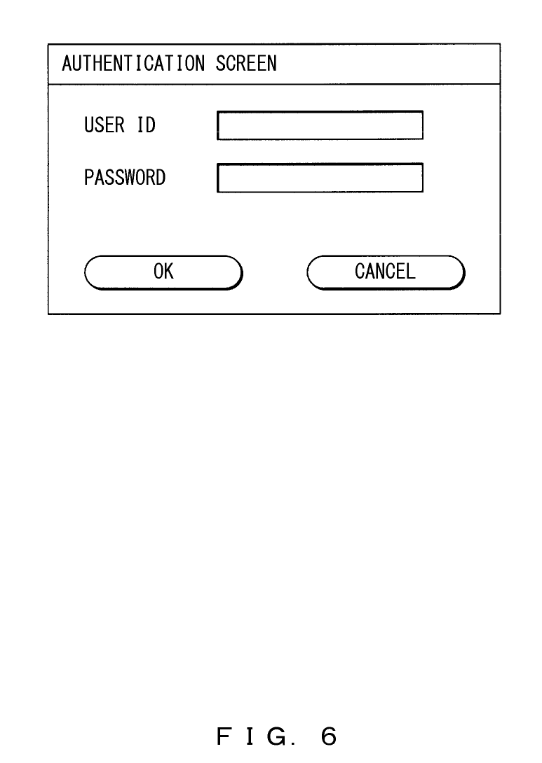

FIG. 6 is a diagram illustrating an example of a display of the authentication screen. The authentication screen has entry fields for authentication information. The authentication information includes a user ID and a password. The authentication screen is output to the released devices 3 (output equipment). The user ID is associated with an arbitrary one or more of the virtual machines 4, and stored in the virtual machine management table (not illustrated). The association is carried out by the CPU 10 at the time of login. The virtual machine management table is stored in the auxiliary storage device 15.

The device processing sorting unit 55 controls the devices 3 released from the virtual machines 4. The device processing sorting unit 55 receives authentication information from an arbitrary one or more of the released devices 3 (input equipment). The device processing sorting unit 55 outputs the received authentication information to the authentication unit 54, and displays the information on the authentication screen.

An end user, while recognizing the authentication screen output to an arbitrary one or more of the released devices 3 (output equipment), inputs authentication information by using an arbitrary one or more of the released devices 3 (input equipment).

The authentication unit 54 executes the following authentication processing. The authentication unit 54 compares the received authentication information with the authentication information table (not illustrated). The authentication information table stores the user IDs and passwords. The user IDs and passwords are registered in advance by the end user. The authentication unit 54, when it is found that the received authentication information is registered in the authentication information table, outputs a notice reporting the authentication success to the device processing sorting unit 55.

The device processing sorting unit 55, when receiving the success of authentication from the authentication unit 54, associates the devices 3 (input equipment) that received the authentication information with the devices 3 (output equipment) that displayed the authentication information. As described above, when a single device 3 (output equipment) is shared by plural end users, the disclosed information processing device 1 can associate the devices 3 (input equipment) with the devices 3 (output equipment) that the end users use.

Furthermore, the device processing sorting unit 55 directly assigns the devices 3 to the virtual machines 4 or assigns emulated devices to the virtual machines 4. The device processing sorting unit 55, when receiving a user ID and an allocation request of the devices 3, extracts the identification information of the virtual machines 4 corresponding to the received user ID from the virtual machine management table (not illustrated). The device processing sorting unit 55 associates the identification information of the extracted virtual machines 4 with the identification information of the devices 3 and stores the association in the device management table 51. As a result, the devices 3 are in a state of being assigned to the virtual machines 4.

The device emulator 56, when the emulated devices are assigned to the virtual machines 4, generates virtual resources by abstracting the physical nature of the devices 3. The device processing sorting unit 55 assigns the generated virtual resources to the virtual machines 4 instead of the devices 3.

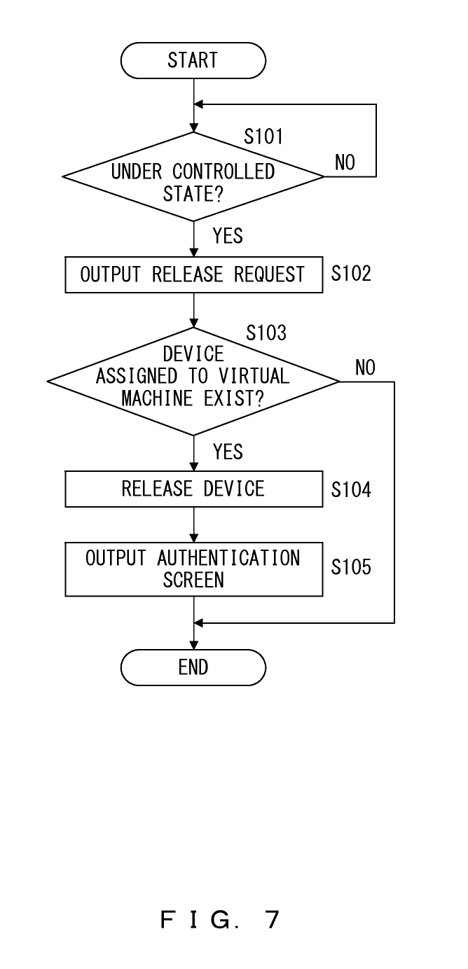

The CPU 10 of the information processing device 1 executes the following processing by fulfilling the function of the virtual machines 4 and the function of the virtual machine monitor 5. FIG. 7 is a flowchart illustrating procedures of device release processing executed by the information processing device 1 in Embodiment 1.

The virtual machine 4 determines whether the virtual machine itself is in a state of being controlled by the remote control or not (S101). For example, the virtual machine 4 determines whether the virtual machine itself is in the state of being controlled by the remote control by receiving the remote connection request for the control terminal 2. An example of this determination method is applicable in the same manner to the other embodiments. When the virtual machine 4 determines that the virtual machine itself is not in a controlled state (NO in S101), the determination in step S101 is repeated.

Meanwhile, when the virtual machine 4 determines that the virtual machine 4 itself is in the controlled state (YES in step S101), it outputs to the virtual machine monitor 5 a request for releasing a device 3 connected to the virtual machine itself.

The virtual machine monitor 5 accesses the device management table 51, and determines whether the devices 3 assigned to the requested virtual machines 4 are present or not (S103). When the virtual machine monitor 5 determines that the assigned devices 3 are not present (NO in S103), it terminates the processing. For example, the device management table 51 is referenced with a key of the identification information of the requested virtual machines 4 (VMID), and if the identification information of a device ID 3 (device ID) is not associated with or not stored in the identification information of the virtual machines 4, or if the identification information of the virtual machines 4 does not exist, the virtual machine monitor 5 determines that the devices 3 assigned to the requested virtual machines 4 do not exist. Alternately, the device management table 51 is for example referenced with a key of the identification information of the requested virtual machines 4 (VMID), and when the identification information of the device ID 3 (device ID) is associated with and stored in the identification information of the virtual machines 4, the virtual machine monitor 5 determines that the devices 3 assigned to the requested virtual machines 4 exist. It should be noted that an example of this determination method can be adopted in other embodiments in the same manner.

Meanwhile, when the virtual machine monitor 5 determines that the assigned devices 3 exist (YES in S103), it releases the devices 3 from the virtual machines 4 and deletes the corresponding records from the device management table 51 (S104). The virtual machine monitor 5 outputs an authentication screen to the released devices 3 (output equipment) (S105). The virtual machine monitor 5 terminates the processing. The virtual machine monitor 5 waits for an input of authentication information.

As described above, when remote controls over the virtual machines 4 to which the devices 3 are connected are started, the disclosed virtual computer system releases the devices 3 from the virtual machines 4. The released devices 3 become assignable to other virtual machines 4. As a result, more virtual machines 4 can be controlled.

### Embodiment 2

When the devices 3 are released from the virtual machines 4, the disclosed virtual computer system, information processing device, computer program, and connection control method may check with the end user who uses the virtual machines 4 whether the devices 3 can be released or not. Details of this mode are explained below as Embodiment 2.

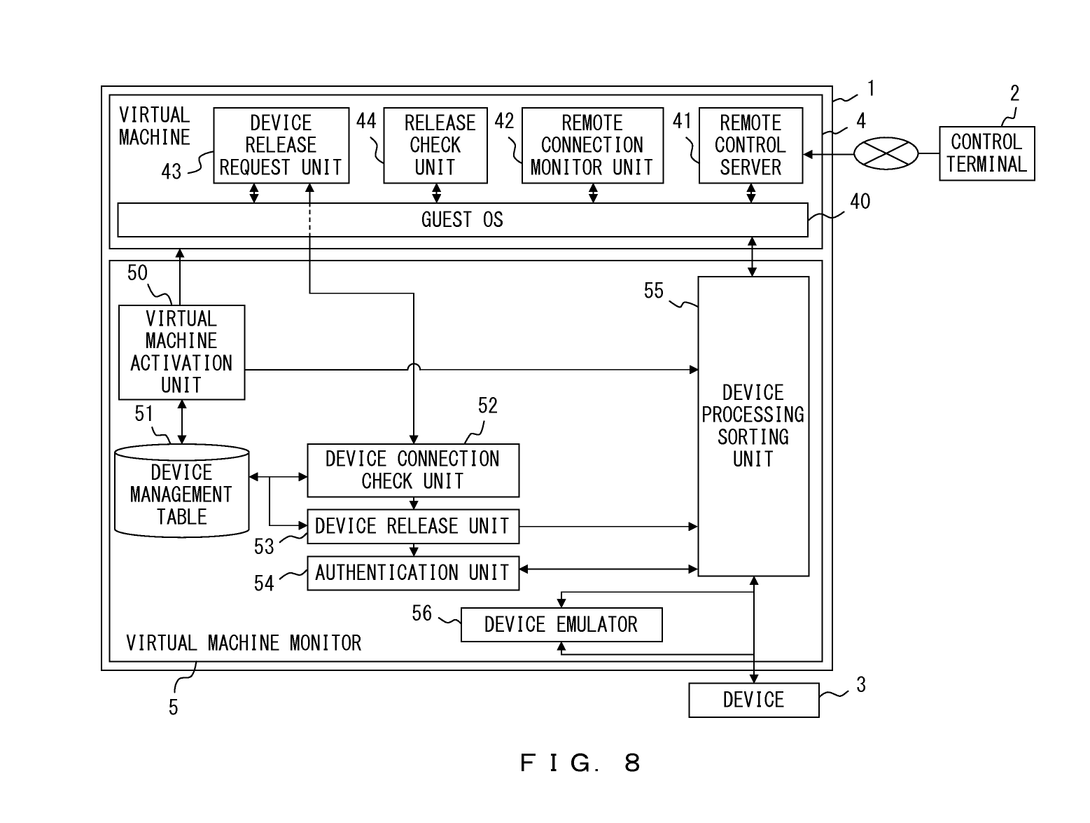

FIG. 8 is a functional block diagram of the information processing device 1 in Embodiment 2. The information processing device 1 has a virtual machine 4 and a virtual machine monitor 5.

The virtual machine 4 has a release check unit 44 in addition to the functions that the virtual machine 4 has in Embodiment 1. The remote connection monitor unit 42 outputs a request for releasing device 3 to the release check unit 44. The release check unit 44, when receiving the release request from the remote connection monitor unit 42, transmits a release check screen to the control terminal 2.

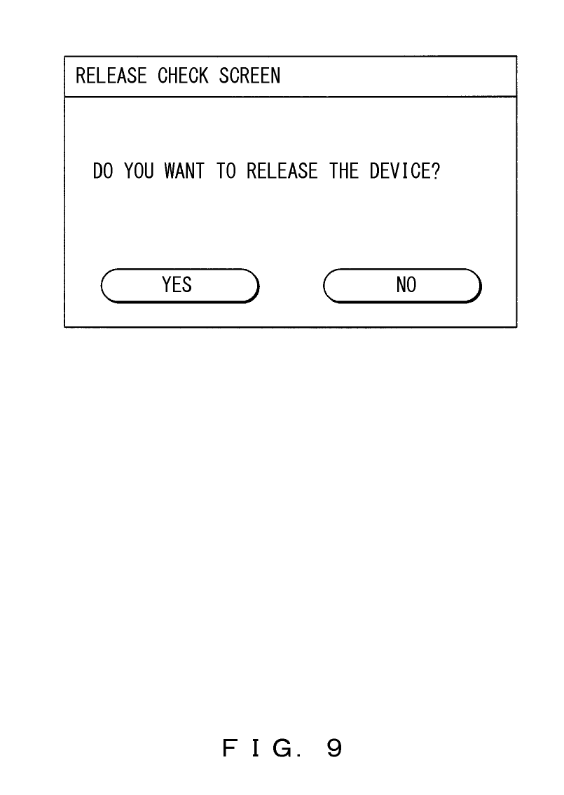

FIG. 9 is a diagram illustrating an example of a display of the release check screen. The release check screen is permission information for inquiring whether the device 3 can be released or not. The release check screen has a display region on which a message of releasing the device 3 is displayed, a permission button (a button displaying “YES” in FIG. 9) for inputting permission to release the device 3, and a rejection button (a button displaying “NO” in FIG. 9). The release check screen is output on the display (not illustrated) of the control terminal 2. The control terminal 2 receives an answer permitting the release or an answer rejecting the release by receiving the user control of either of the buttons through the control unit (not illustrated). The control terminal 2 transmits the received answer to the release check unit 44.

The release check unit 44 receives the answer transmitted from the control terminal 2. When the release check unit 44 receives an answer permitting the release, it outputs the request for releasing the device 3 to the device release request unit 43. When the release check unit 44 receives an answer rejecting the release, it cancels the release of the device 3.

It should be noted that the entire configuration of the virtual computer system, the configuration of the information processing device 1, and the stored contents in the auxiliary storage device 15 are the same as those in Embodiment 1, and thus the corresponding components are provided with the same reference codes and detailed explanations are omitted.

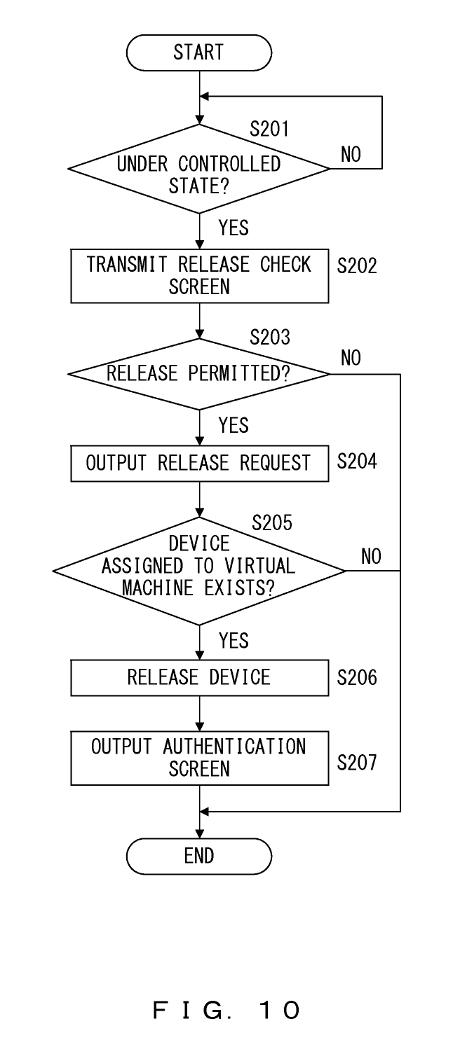

The CPU 10 of the information processing device 1 executes the following processing by fulfilling the function of the virtual machine 4 and the function of the virtual machine monitor 5. FIG. 10 is a flowchart illustrating the procedures of the device release processing that the information processing device 1 executes in Embodiment 2.

The virtual machine 4 determines whether the virtual machine itself is in a state of being controlled by the remote control or not (S201). When the virtual machine 4 determines that the virtual machine itself is not in the controlled state (NO in S201), it repeats the determination in step 5201.

On the other hand, when the virtual machine 4 determines that the virtual machine itself is in the controlled state (YES in S201), it transmits the release check screen to the control terminal 2 that is the origin of the control (S202). The virtual machine 4 receives the answer transmitted from the control terminal 2. The virtual machine 4 determines whether an answer permitting the release is received or not (S203). When the virtual machine 4 determines that an answer rejecting the release is received (NO in S203), it terminates the processing.

On the other hand, when an answer permitting the release is received (YES in S203), the virtual machine 4 outputs a request for releasing the device 3 connected to the virtual machine itself to the virtual machine monitor 5 (S204).

The virtual machine monitor 5 accesses the device management table 51 and determines whether the device 3 assigned to the requested virtual machine 4 exists or not (S205). When the virtual machine monitor 5 determines that the assigned device does not exist (NO in S205), it terminates the processing.

On the other hand, when the virtual machine monitor 5 determines that the assigned device 3 exists (YES in S205), it releases the device 3 from the virtual machine 4 and deletes the corresponding records from the device management table 51 (S206). The virtual machine monitor 5 outputs an authentication screen to the released device 3 (output equipment) (S207). The virtual machine monitor 5 terminates the processing. The virtual machine monitor 5 waits until an input of the authentication information.

As described above, in the disclosed virtual computer system, even if an end user who uses the virtual machine 4 by using the device 3 further conducts remote controls over the virtual machine 4 by using the control terminal 2, a situation in which the device 3 is automatically released from the virtual machine 4 despite the intentions of the user can be avoided. For example, if an end user tries to resume the use of the virtual machine 4 by using the device 3 soon after using the virtual machine 4 for a while by using the control terminal 2, it is possible to prevent the device 3 from being automatically released and from being used by another user. When the use of the virtual machine 4 through the device 3 is resumed, authentication processing does not need to be conducted again and convenience for users is improved.

### Embodiment 3

When the disclosed virtual computer system, information processing device, computer program, and connection control method run out of the assignable devices 3, they may put the virtual machine 4 to which the device 3 should be assigned next in a release-waiting state. In addition, when there is a release-waiting virtual machine 4, the device 3 is released from the virtual machine 4 to which the remote control is requested. Details of this mode are explained below as Embodiment 3.

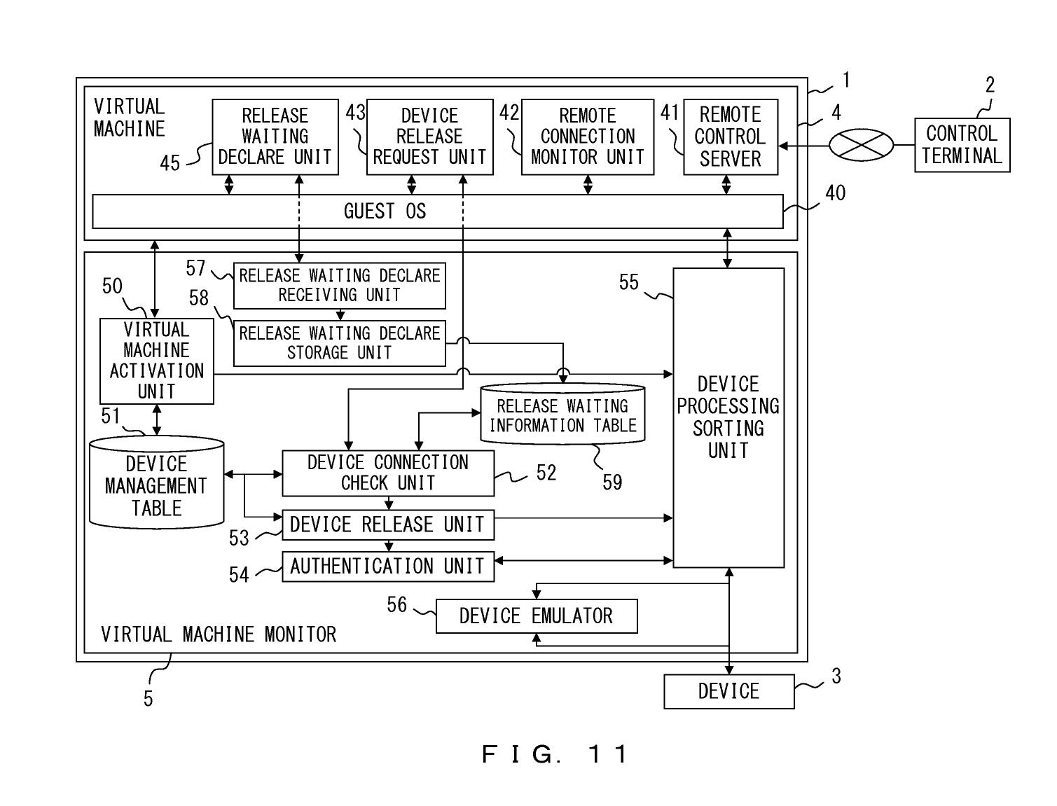

FIG. 11 is a functional block diagram of the information processing device 1 in Embodiment 3. The information processing device 1 has a virtual machine 4 and a virtual machine monitor 5.

The virtual machine 4 has a release waiting declare unit 45 in addition to the function that the virtual machine 4 has in Embodiment 1. The release waiting declare unit 45 receives a declaration that the virtual machine 4 is waiting for the device 3 to be released. The release waiting declaration is input by an end user who uses the virtual machine 4. The release waiting declaration is an assignment request to assign a released device 3 to the virtual machine itself. The release waiting declaration unit 45 outputs the received release waiting declaration and the identification information of the virtual machine itself to the virtual machine monitor 5.

The virtual machine monitor 5 has a release waiting declare receiving unit 57, a release waiting declare storage unit 58, and a release waiting information table 59, in addition to the functions that the virtual machine monitor 5 has in Embodiment 1.

The release waiting declare receiving unit 57 receives the release waiting declaration and the identification information of the virtual machine 4 from the release waiting declare unit 45. The release waiting declare receiving unit 57, when receiving the release waiting declaration, outputs a request to store the release waiting to a release waiting declare storage unit 58.

The release waiting declare storage unit 58, receiving the storage request from the release waiting declare receiving unit 57, stores the identification information of the virtual machine 4 in a release waiting information table 59. The release waiting information table 59 stores the identification information of the release-waiting virtual machine 4.

When the device connection check unit 52 receives the request for releasing the device 3 from the device release request unit 43 and determines that the identification information of the virtual machine 4 is present in the release waiting information table 59, it outputs the request for releasing the device 3 to the device release unit 53.

It should be noted that in the entire configuration of the virtual computer system and the configuration of the information processing device 1, the components that are the same as those in Embodiment 1 are provided with the same reference codes and detailed explanations are omitted.

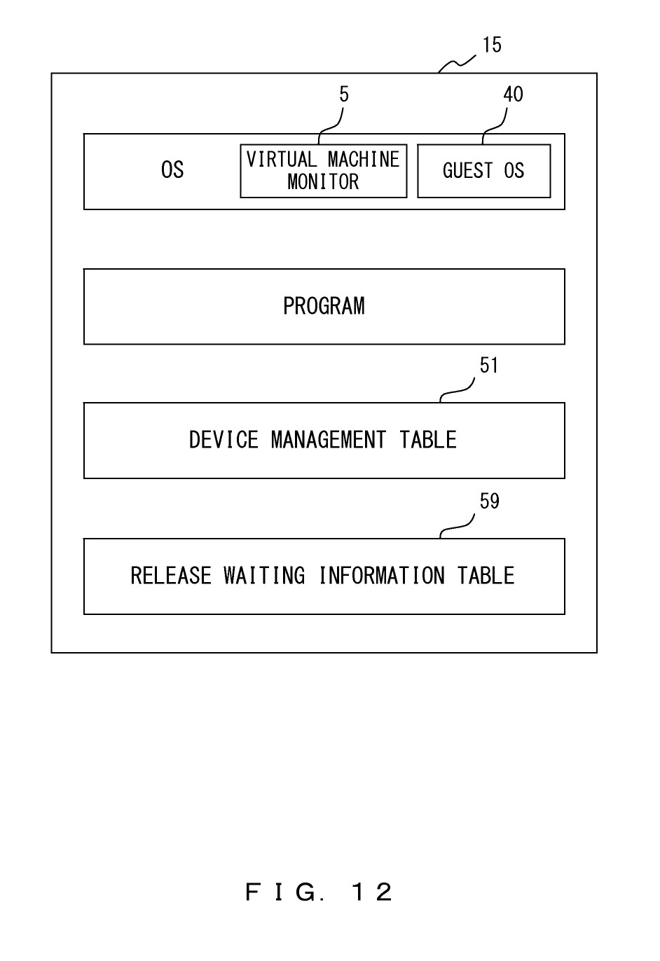

FIG. 12 is a diagram illustrating the storage contents of the auxiliary storage device 15 in Embodiment 3. The auxiliary storage device 15 stores the release waiting information table 59, in addition to the storage contents of the auxiliary storage device 15 in Embodiment 1.

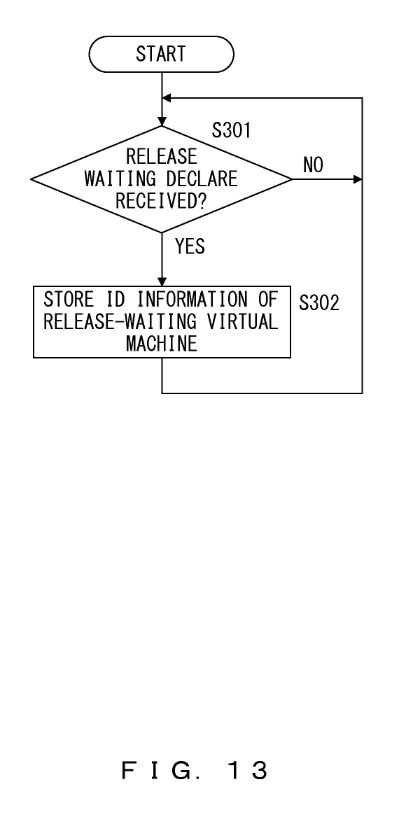

The CPU 10 of the information processing device 1 executes the following processing by fulfilling the function of the virtual machine 4 and the function of the virtual machine monitor 5. FIG. 13 is a flowchart illustrating the procedures of the release waiting declaration processing that the information processing device 1 executes in Embodiment 3.

The virtual machine 4 determines whether the release waiting declaration is received or not (S301). When the virtual machine 4 determines that the release waiting declaration is not received (NO in S301), it repeats the determination in S301.

On the other hand, when the virtual machine 4 determines that the release waiting declaration is received (YES in S301), it outputs the release waiting declaration and the identification information of the virtual machine 4 requesting the release waiting declaration to the virtual machine monitor 5.

The virtual machine monitor 5 stores the received identification information of the virtual machine 4 requesting the release waiting declaration in the release waiting information table 59 (S302). The virtual machine monitor 5 passes the execution right of the processing to the virtual machine 4. The virtual machine 4 repeats the determination in step S301.

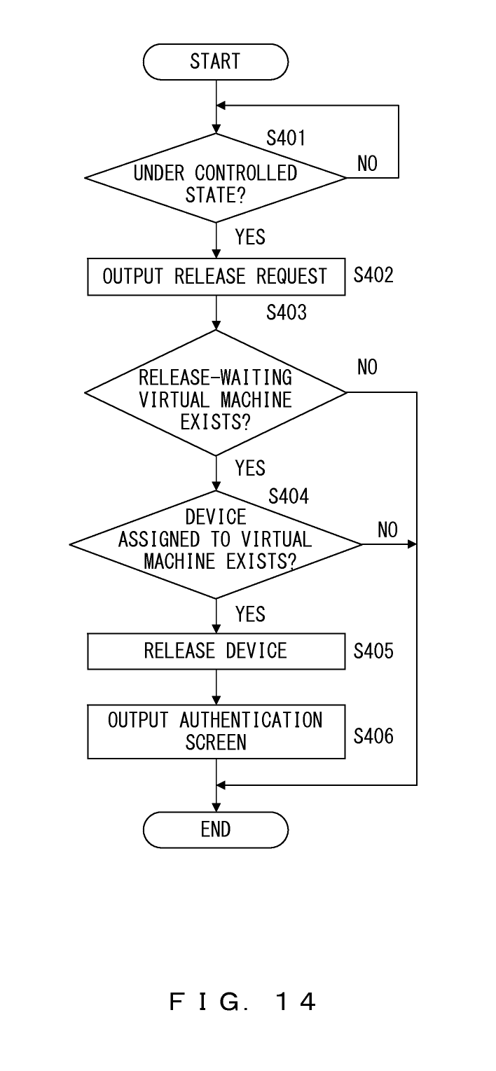

FIG. 14 is a flowchart illustrating the procedures of the device release processing that the information processing device 1 executes in Embodiment 3. The virtual machine 4 determines whether the virtual machine itself is in a state of being controlled by the remote control or not (S401). When the virtual machine 4 determines that the virtual machine itself is not in the controlled state (NO in S401), it repeats the determination of step S401.

On the other hand, when the virtual machine 4 determines that the virtual machine itself is in the controlled state (YES in S401), it outputs the request for releasing the device 3 connected to the virtual machine itself to the virtual machine monitor 5 (S402).

When the virtual machine monitor 5 receives the request for releasing the device 3, it accesses the release waiting information table 59 and determines whether the release-waiting virtual machine 4 exists or not (S403). When the virtual machine monitor 5 determines that the release-waiting virtual machine 4 does not exist (NO in S403), it terminates the processing.

Meanwhile, when the virtual machine monitor 5 determines that the release-waiting virtual machine 4 exists (YES in S403), it accesses the device management table 51 and determines whether a device 3 assigned to the virtual machine 4 to which the remote control is requested exists or not (S404). The virtual machine monitor 5 terminates the processing when it determines that the assigned device 3 does not exist (NO in S404).

On the other hand, when the virtual machine monitor 5 determines that the assigned device 3 exists (YES in S404), it releases the device 3 from the virtual machine 4 and deletes the corresponding records from the device management table 51 and the release waiting information table 59 (S405). The virtual machine monitor 5 outputs an authentication screen to the released device 3 (output equipment) (S406). The virtual machine monitor 5 terminates the processing. The virtual machine monitor 5 waits for an input of the authentication information.

As described above, the disclosed virtual computer system determines that the device release is not necessary when the release-waiting virtual machine 4 does not exist. When the disclosed virtual computer system determines that the device release is unnecessary, it avoids the case in which the device 3 is released. As a result, end users can operate the virtual machine 4 through the device 3, if at all possible. When no user wishing to use the device 3 exists, the unnecessary release processing of the device 3 is avoided so that the processing load of the information processing device 1 can be reduced.

The information processing device 1 also assigns the released device 3 to the virtual machine 4 in accordance with the order of release waiting. For example, when the identification information of the virtual machine 4 to which the release-waiting declaration is requested is stored in the release waiting information table 59, the time and date of reception of the release waiting declaration are associated and stored with the identification information. The device processing sorting unit 55 accesses the release waiting information table 59 and extracts the identification information of the virtual machine 4 in which the associated data and time of reception of the release waiting declaration is the oldest. The device processing sorting unit 55 associates the extracted identification information of the virtual machine 4 with the identification information of a device 3 and stores the identification information in the device management table 51. As a result, the device 3 is in a state of being assigned to the virtual machine 4 in accordance with the order of release waiting. It should be noted that other than the time and date of reception of the release waiting declaration, information that allows the order of reception of release waiting to be determined, such as serial numbers that are in the order of reception of release waiting, may be used.

The information processing device 1, furthermore, assigns the released device 3 to the virtual machine 4 in order of prescribed priority. More specifically, the device processing sorting unit 55 selects a virtual machine 4 in which the time and date of activation is the oldest. The device processing sorting unit 55 associates the identification information of the selected virtual machine 4 with the identification information of the device 3 and stores the identification information in the device management table 51. As a result, the device 3 is in a state of being assigned to the virtual machine 4 in the order of prescribed priority.

The prescribed priority is not limited to an example of a higher priority for the older time and date of activation, but a more recent time and date of activation may have a higher priority. The prescribed priority can be higher as the processing load of the CPU 10 becomes greater.

### Embodiment 4

The disclosed virtual computer system, information processing device, computer program, and connection control method may output a notice of release of a device 3 to the release-waiting virtual machine 4. Details of this mode are explained below as Embodiment 4.

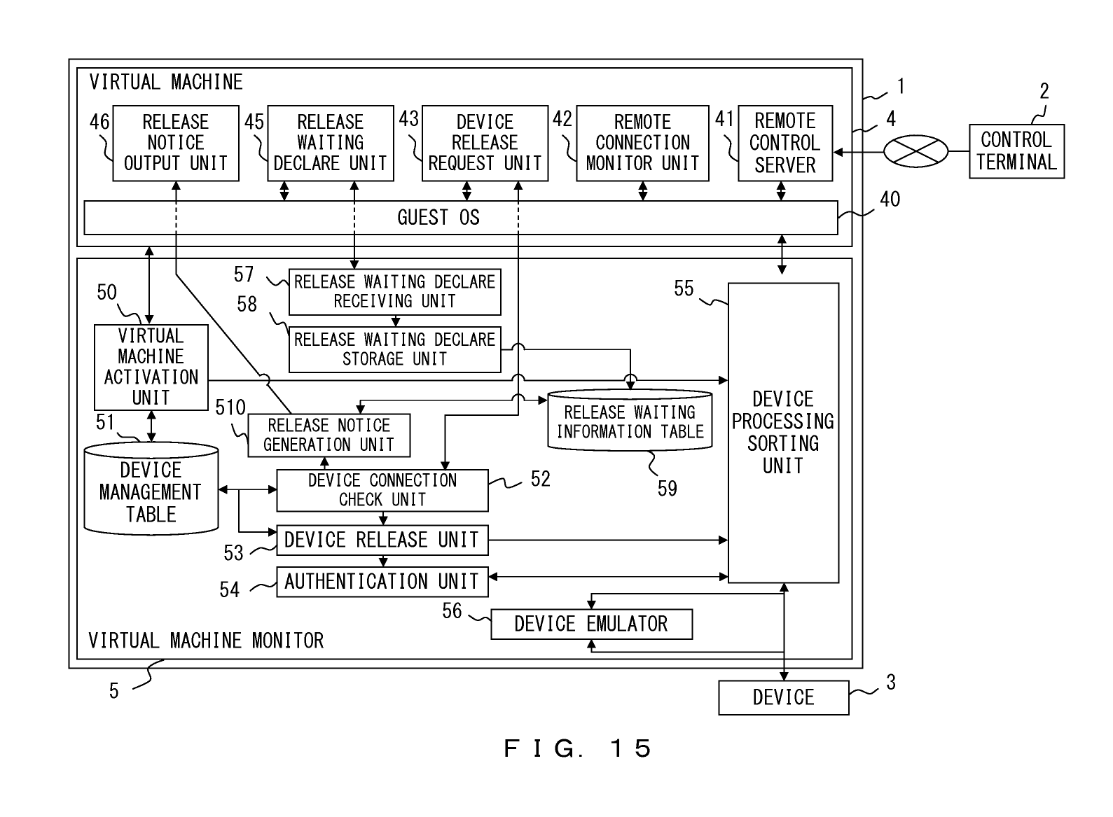

FIG. 15 is a functional block diagram of the information processing device 1 in Embodiment 4. The information processing device 1 has a virtual machine 4 and a virtual machine monitor 5.

The virtual machine 4 has a release notice output unit 46 in addition to the functions that the virtual machine 4 has in Embodiment 3. The release notice output unit 46 receives the release notice output from the virtual machine monitor 5. The release notice output unit 46 reports the received release notice to end users.

The virtual machine monitor 5 has a release notice generation unit 510 in addition to the functions that the virtual machine monitor 5 has in Embodiment 3. The release notice generation unit 510, when receiving a notice of release of a device 3 from a device connection check unit 52, generates a release notice for reporting to the end users of the virtual machine 4 that requested the release waiting declaration that a device 3 has been released. The release notice generation unit 510 accesses the release waiting information table 59, and extracts the identification information of the release-waiting virtual machine 4. The release notice generation unit 510 outputs the release notice to the display unit of the control terminal 2 using the virtual machine 4 that the extracted identification information indicates.

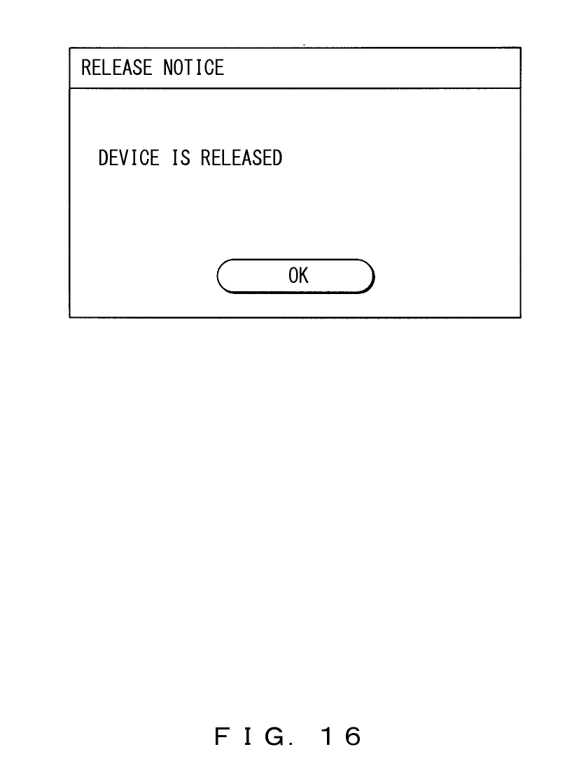

FIG. 16 is a diagram illustrating a display example of a release notice. The release notice has a display region that displays a message that the device 3 has been released and a completion button (a button with an indication of “OK” in FIG. 16) for input of check completion. The release notice is output on the display of the control terminal 2. The control terminal 2 receives the check completion through the control unit and outputs the check completion to the virtual machine 4. In this example, only cases in which a release has occurred are displayed. However, which of the devices 3 is released may be displayed by obtaining the device information of the released device 3 from the device management table 51.

It should be noted that since the entire configuration of the virtual computer system, the configuration of the information processing device 1, and the stored contents in the auxiliary storage device 15 are the same as those in Embodiment 3, the same components are provided with the same reference codes and detailed explanations are omitted.

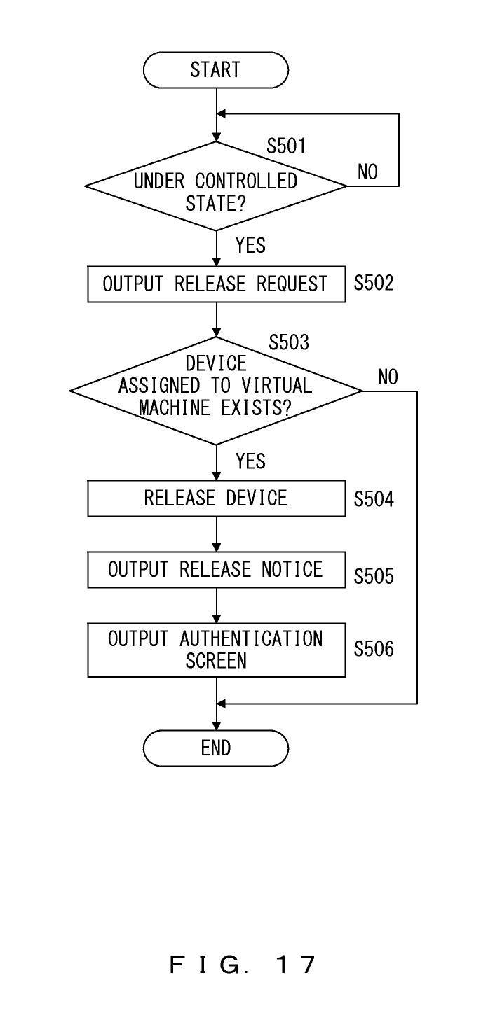

The CPU 10 of the information processing device 1 executes the following processing by fulfilling the function of the virtual machine 4 and the function of the virtual machine monitor 5. FIG. 17 is a flowchart illustrating the procedures of the device release processing executed by the information processing device 1 in Embodiment 4.

The virtual machine 4 determines whether the virtual machine itself is in a state of being controlled by the remote control or not (S501). When the virtual machine 4 determines that the virtual machine itself is not in the controlled state (NO in S501), it repeats the determination in step S501.

Meanwhile, when the virtual machine 4 determines that the virtual machine itself is in the controlled state (YES in S501), it outputs to the virtual machine monitor 5 the request for releasing the device 3 connected to the virtual machine itself (S502).

The virtual machine monitor 5 accesses the device management table 51, and determines whether a device 3 assigned to the virtual machine 4 that made the request exists or not (S503). When the virtual machine monitor 5 determines that the assigned device 3 does not exist (NO in S503), it terminates the processing.

On the other hand, when the virtual machine monitor 5 determines that the assigned device 3 exists (YES in S503), it releases the device 3 from the virtual machine 4 (S504) and deletes the corresponding records from the device management table 51 and the release waiting information table 59. The virtual machine monitor 5 outputs a release notice to the display unit of the control terminal 2 using the virtual machine 4 that requested the release waiting (S505). Meanwhile, the virtual machine monitor 5 outputs an authentication screen to the released device 3 (output equipment) (S506). The virtual machine monitor 5 terminates the processing. The virtual machine monitor 5 waits for an input of the authentication information.

As described above, the disclosed virtual computer system, after releasing a device 3, causes the display unit of the control terminal 2 using the virtual machine 4 that requested the release waiting to report that the device 3 has been released so that the end users waiting for release of the device 3 immediately recognize that the device 3 has been released. The release-waiting end users can promptly check that there is a device 3 that was released from the virtual machine 4 and can be assigned to the virtual machine itself.

It should be noted that in the above-described embodiment, an example in which the release notice generation unit 501 outputs a release notice to all of the release-waiting virtual machines 4 is explained. However, the disclosed virtual computer system is not limited to this example, but the release notice generation unit 501 may output a release notice only to a virtual machine 4 with the oldest time and date of release waiting, or may prioritize the users of the release-waiting virtual machine 4 and output a release notice in the order of higher priority.

### Embodiment 5

In Embodiments 1 to 4, an example of releasing a device 3 from a virtual machine 4 is explained. However, the disclosed virtual computer system information processing device, computer program, and connection control method are not limited to these embodiments, but may release the remote control over the virtual machine 4. Details of this mode are explained below as Embodiment 5.

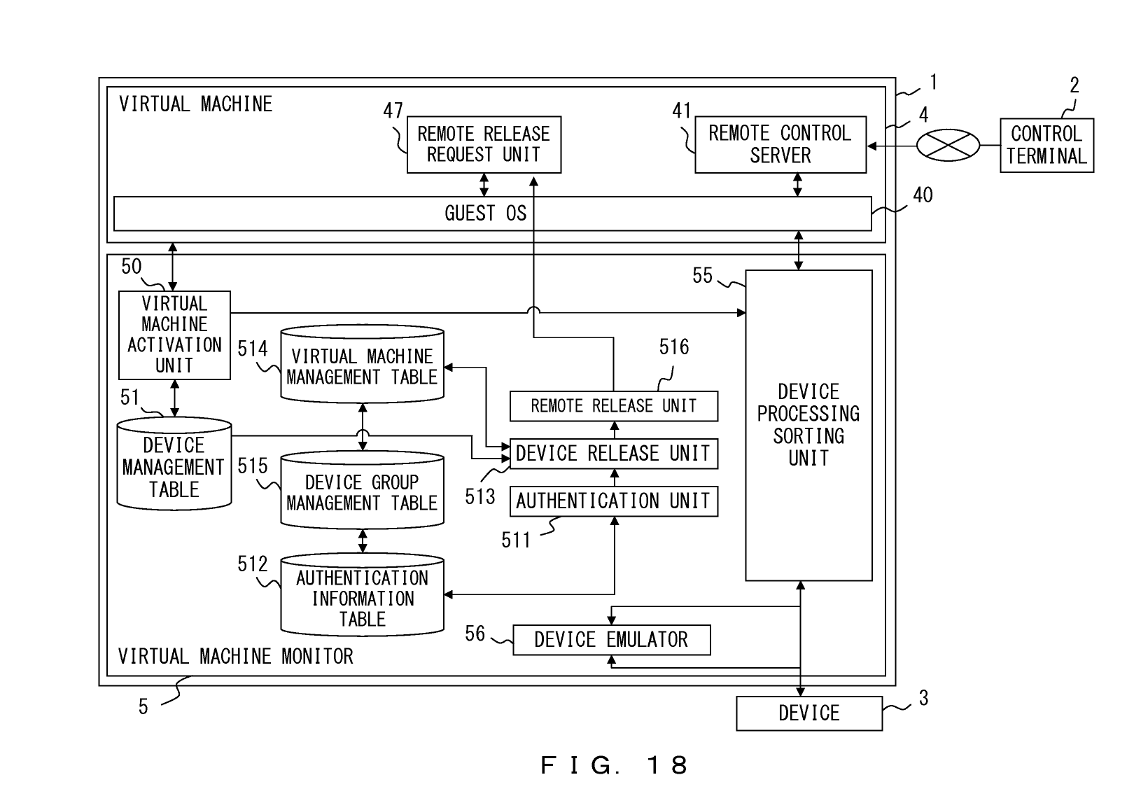

FIG. 18 is a functional block diagram of the information processing device 1 in Embodiment 5. The information processing device 1 has a virtual machine 4 and a virtual machine monitor 5.

The virtual machine 4 has a guest OS 40, a remote control server 41, and a remote release request unit 47. The guest OS 40 activates within the virtual machine 4 and controls the virtual resources of the virtual machine 4.

When the remote release request unit 47 receives from a remote release unit 516 described later a request for releasing the remote control, it outputs the request to the remote control server 41.

When the remote control server 41 receives the release request from the remote release request unit 47, it rejects reception of remote control of the control terminal 2. As a result, the remote control is in a state of being released from the virtual machine 4.

The virtual machine monitor 5 has a virtual machine activation unit 50, the device management table 51, the device processing sorting unit 55, the device emulator 56, an authentication unit 511, an authentication information table 512, a device connection unit 513, a virtual machine management tale 514, a device group management table 515, and a remote release unit 516.

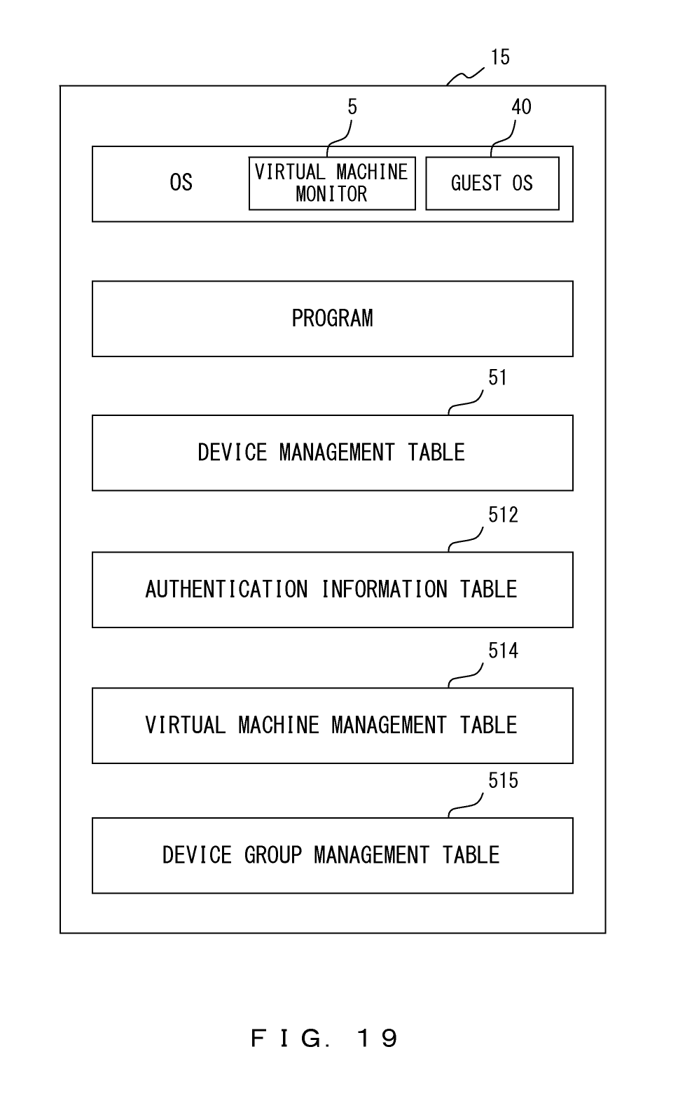

FIG. 19 is a diagram illustrating the stored contents of the auxiliary storage device 15 in Embodiment 5. The auxiliary storage device 15 stores the authentication information table 512, the virtual machine management table 514, and the device group management table 515 in addition to the storage contents of the auxiliary storage device 15 in Embodiment 1.

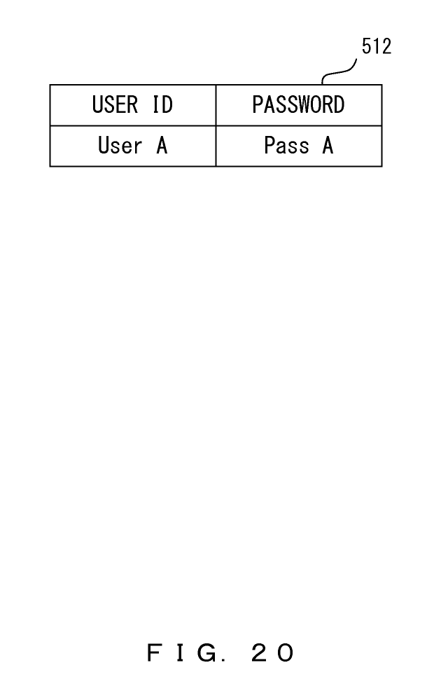

FIG. 20 is a diagram illustrating an example of the format of the authentication information table 512. The authentication information table 512 associates a user ID with a password and stores them.

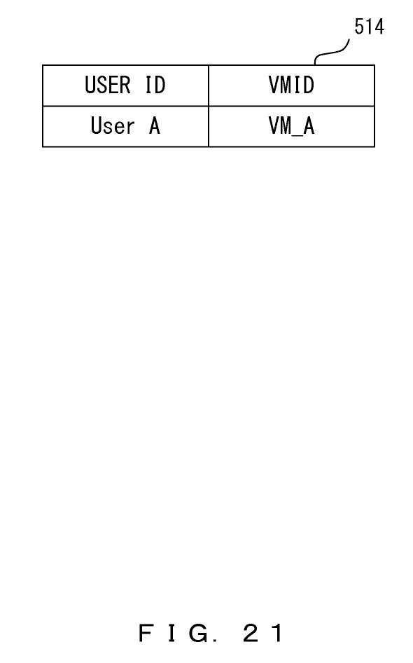

FIG. 21 is a diagram illustrating an example of the format of the virtual machine management table 514. The virtual machine management table 514 associates a user ID with the identification information of the virtual machine 4 (VMID) and stores them. The association of the user ID with the virtual machine 4 is executed by the CPU 10, which is triggered by a user inputting a user ID and a password on an authentication screen and performs a login operation to the virtual machine 4, and the association is stored in the virtual machine management table 514.

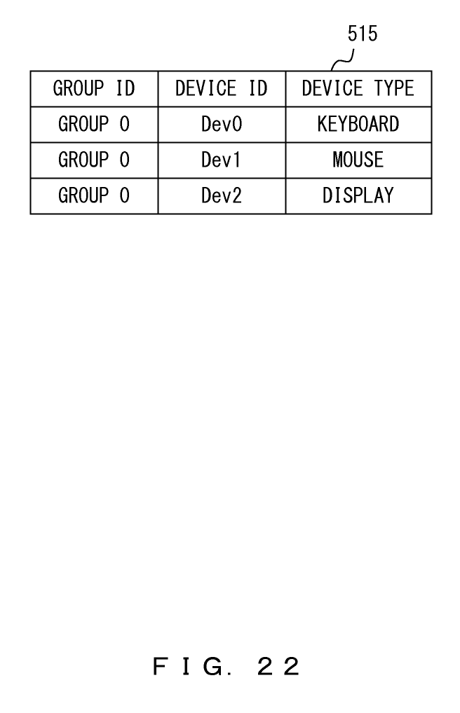

FIG. 22 is a diagram illustrating an example of the format of the device group management table 515. The device group management table 515 associates plural pieces of identification information of the devices 3 assigned to the virtual machine 4, and stores the associated information as a group. The device group management table 515 associates identification information of groups (group ID), identification information of the device 3 (device ID), and the type of the device 3 (device type), and stores them.

Since the virtual machine activation unit 50, the device management table 51, and the device emulator 56 are the same as those in Embodiment 1, the corresponding components are provided with the same reference codes and detailed explanations are omitted.

The device processing sorting unit 55 receives authentication information from an arbitrary one or more of the devices 3 (input equipment). The device processing sorting unit 55 outputs the received authentication information to the authentication unit 511, and causes the device 3 (output equipment) corresponding to the device 3 (input equipment) to display the information on the authentication screen.

The authentication unit 511 outputs the authentication screen (see FIG. 6) to the device 3 (output equipment) that is not used by the virtual machine 4. The authentication unit 511 executes the following authentication processing. When the authentication unit 511 receives the authentication information from the device processing sorting unit 55, it compares the received authentication information with the authentication information table 512. When the authentication unit 511 determines that the received authentication information is stored in the authentication information table 512, it outputs a notice of the success in authentication to the device connection unit 513.

When the device connection unit 513 receives a notice of success in authentication from the authentication unit 511, it accesses the virtual machine management table 514 and extracts the identification information of the virtual machine 4 corresponding to the user ID. The device connection unit 513 accesses the device group management table 515 and extracts the identification information of all of the devices 3 that belong to the same group as the group of the device 3 (input equipment) from which the identification information is input.

The device connection unit 513 associates the identification information of the virtual machine 4 extracted in the device connection unit 513 with the identification information of the device 3 and stores the information in the device management table 51. As a result, the device 3 is in a state of being assigned to the virtual machine 4. The device connection unit 513 outputs the identification information of the virtual machine 4 having the device 3 assigned to it to the remote release unit 516.

When the remote release unit 516 receives the identification information of the virtual machine 4 from the device connection unit 513, it outputs a release request requesting release of the remote control to the virtual machine corresponding to the identification information of the received virtual machine 4.

It should be noted that since the entire configuration of the virtual computer system and the configuration of the information processing device 1 are the same as those in Embodiment 1, the same components are provided with the same reference codes and detailed explanations are omitted.

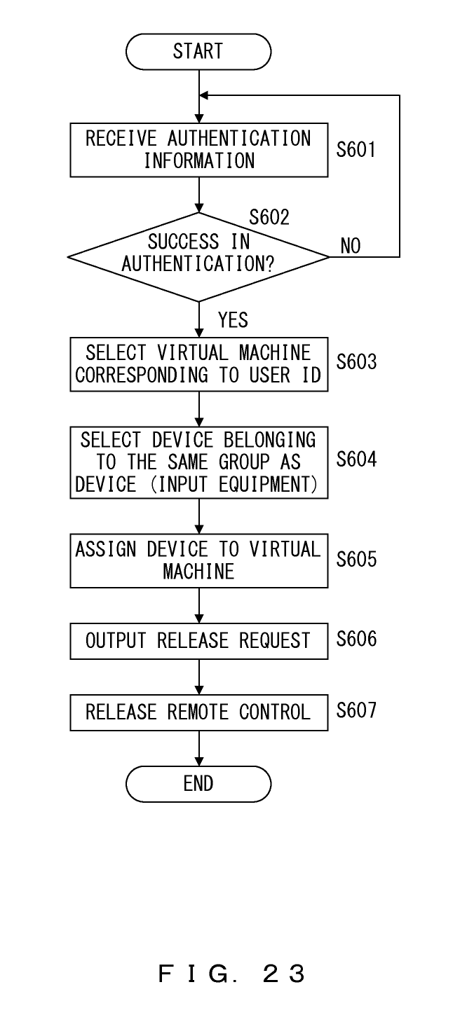

The CPU 10 of the information processing device 1 executes the following processing by fulfilling the function of the virtual machine 4 and the function of the virtual machine monitor 5. FIG. 23 is a flowchart illustrating the procedures of device release processing executed by the information processor device 1 in Embodiment 5.

The virtual machine monitor 5 outputs an authentication screen to a device 3 (output equipment) that is not used by the virtual machine 4. The virtual machine monitor receives authentication information input through an arbitrary one or more of the devices 3 (input equipment) (S601). The virtual machine monitor 5 executes authentication processing based on the received authentication information. The virtual machine monitor 5 determines whether the authentication succeeded or not (S602). When the virtual machine monitor 5 determines that the authentication was a failure (NO in S602), it repeats the determination in step S601.

Meanwhile, when the virtual machine monitor 5 determines that the authentication was a success (YES in S602), it selects the virtual machine 4 corresponding to the user ID (S603). The virtual machine monitor 5 selects a device 3 that belongs to the same group as the group of the device 3 (input equipment) from which the authentication information is input (S604). The virtual machine monitor 5 assigns the selected device 3 to the virtual machine 4 (S605). The virtual machine monitor 5 outputs to the virtual machine 4 a release request for releasing the remote control of the control terminal 2 to the selected virtual machine 4 (S606).

When the virtual machine 4 receives from the virtual machine monitor 5 the release request for releasing the remote control of the control terminal 2, it releases the remote control of the control terminal 2 from the virtual machine itself (S607). Afterwards, the virtual machine 4 performs transmission and reception of input/output information with a newly authenticated device 3, and continues the processing.

As described above, in the disclosed virtual computer system, when a device 3 is assigned to the virtual machine 4 that is in a state of being controlled by the control terminal 2 through remote control, it releases the remote control of the control terminal 2 from the virtual machine 4. The released control terminal 2 can be used by another virtual machine 4. As a result, opportunities for operating the virtual machine 4 can be increased when there is no available device 3, or when an end user wishes to use a virtual machine through the remote control of the control terminal 2 regardless of a slight reduction in performance.

### Embodiment 6

In Embodiments 1 to 5, an example in which a virtual machine 4 has means to detect a state of being controlled through remote controls and means to request the release of a device 3 is explained. However, the disclosed virtual computer system, information processing device 1, computer program, and connection control method are not limited to this example, but devices other than the virtual machine 4 can have these means. Details of this mode are explained below as Embodiment 6.

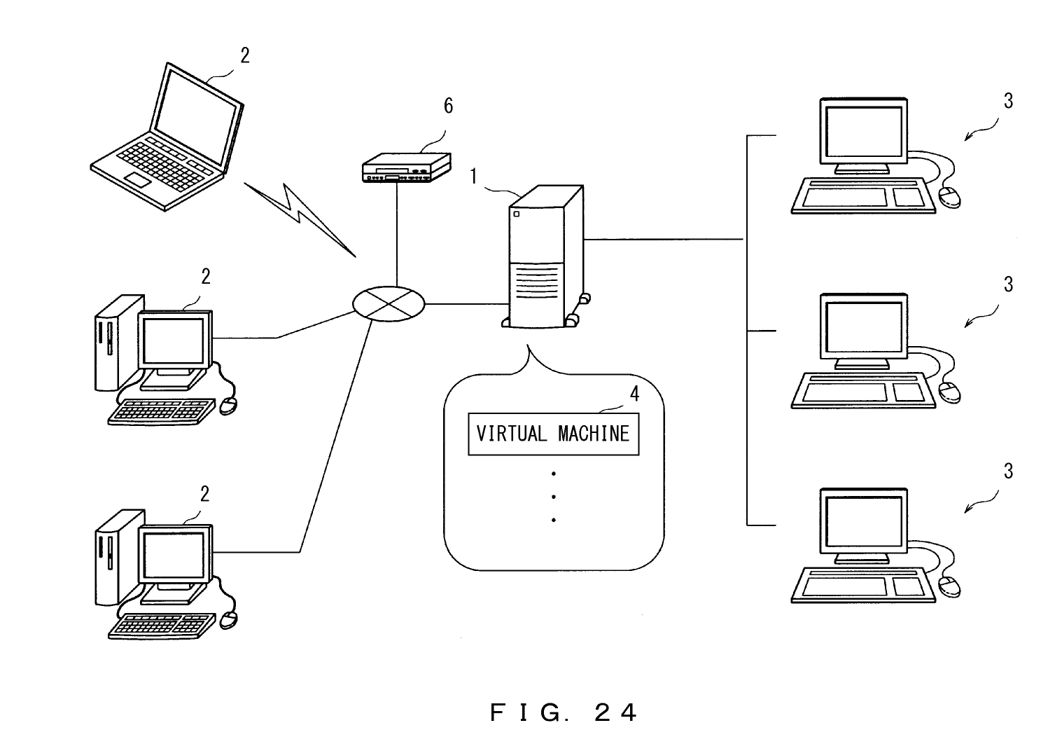

FIG. 24 is a diagram illustrating the entire configuration of the virtual computer system in Embodiment 6. In FIG. 24, the same components as those in Embodiment 1 are provided with the same reference codes, and explanations are omitted. A connection broker 6 can be connected to the information processing device 1 over a computer network. The connection broker 6 has means to detect a state of being controlled through remote controls and means to request the release of a device 3.

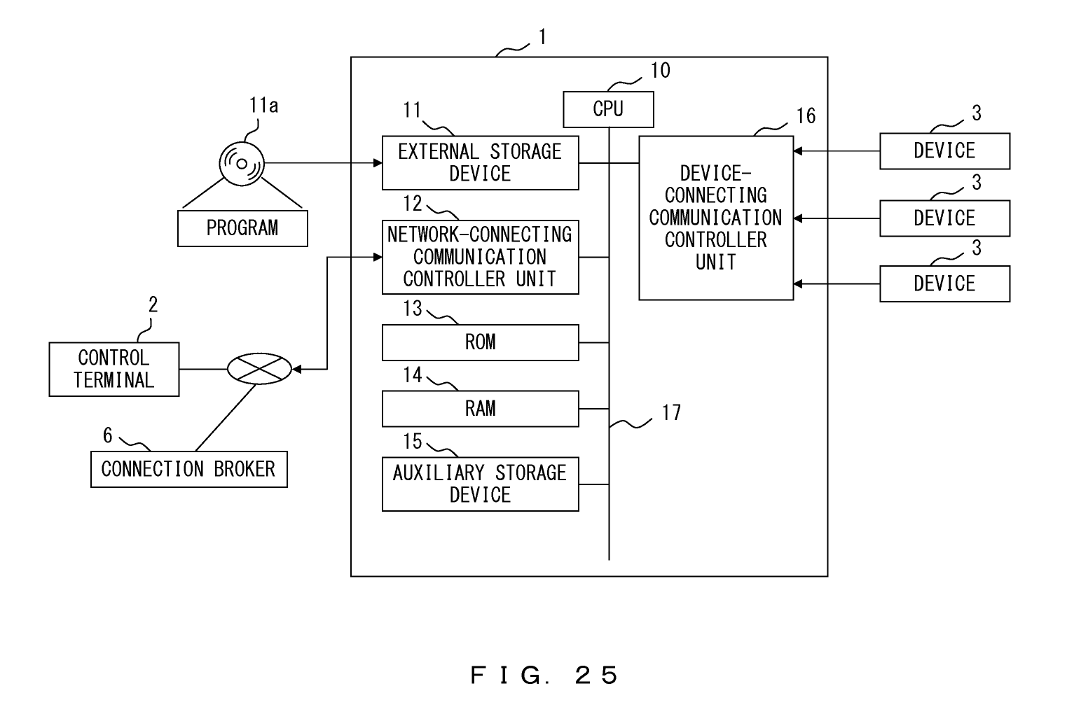

FIG. 25 is a block diagram illustrating the configurations of the information processing device 1 and its peripheral devices in Embodiment 6. A network-connecting communication controller unit 12 is a resource for receiving the remote control of each control terminal 2 over the computer network. The network-connecting communication controller unit 12 is also a resource for connecting to the connection broker 6 over the computer network. It should be noted that since the rest of the hardware resources are the same as those in Embodiment 1, the same components are provided with the same reference codes and detailed explanations are omitted.

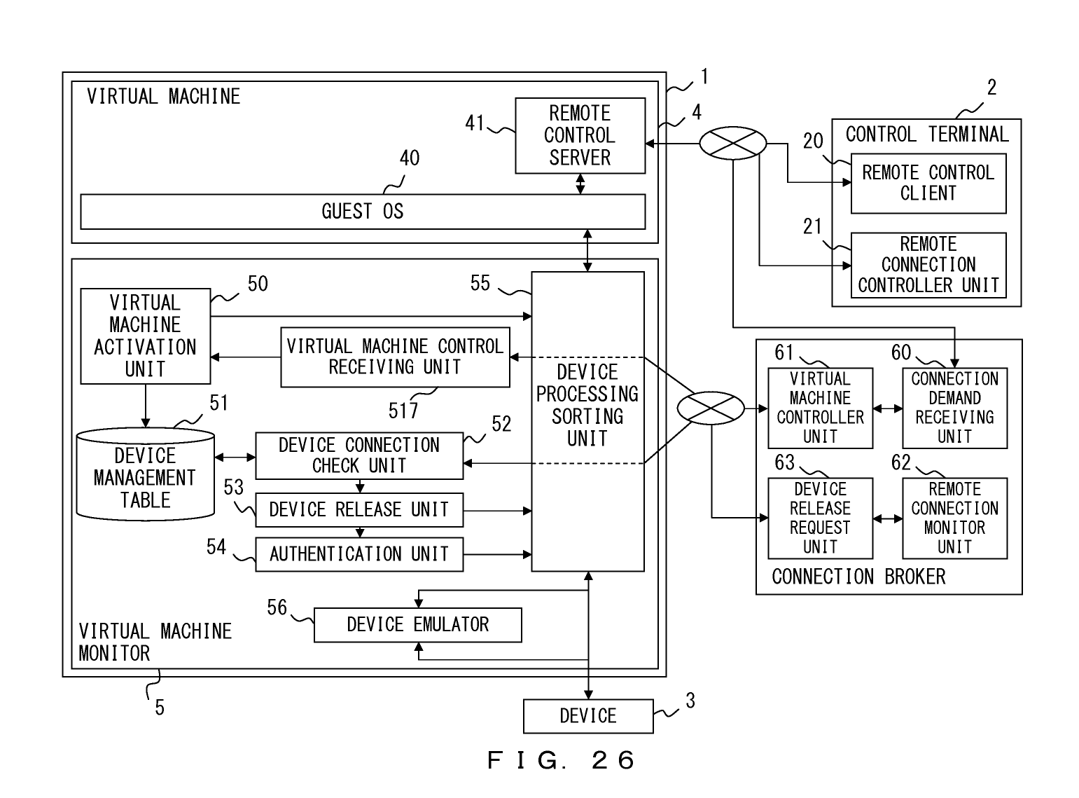

FIG. 26 is a functional block diagram of the information processing device 1 and peripheral devices in Embodiment 6.

The control terminal 2 has a remote control client 20 and a remote connection controller unit 21. The remote connection controller unit 21 receives a start request for starting a remote control over any one or more virtual machines 4 and a user ID from the input of an end user. The remote connection controller unit 21 transmits the received start request and user ID to the connection broker 6. The remote connection controller unit 21 receives an address of the virtual machine 4 corresponding to the user ID from the virtual machine monitor 5 through the connection broker 6. The remote connection controller unit 21 outputs the address of the received virtual machine 4 to the remote control client 20.

The remote control client 20 receives the address of the virtual machine 4 from the remote connection controller unit 21. The remote control client 20 executes the remote control over the virtual machine 4 that the received address indicates. The remote control client 20 receives displayed screen information from the virtual machine 4.

The connection broker 6 has a connection demand receiving unit 60, a virtual machine controller unit 61, a remote connection monitor unit 62, and a device release request unit 63.

The connection demand receiving unit 60 receives a start request to start remote control and a user ID from the control terminal 2. The connection demand receiving unit 60 outputs the received start request and user ID to the virtual machine controller unit 61.

The virtual machine controller unit 61 receives the start request and the user ID from the connection demand receiving unit 60. The virtual machine controller unit 61 transmits the received start request and user ID to the virtual machine monitor 5.

The remote connection monitor unit 62 detects whether the remote control over the virtual machine 4 has been enabled or not. The remote connection monitor unit 62, when detecting the remote control over the virtual machine 4, outputs a request to release the device 3 to the device release request unit 63.

When the device release request unit 63 receives the release request from the remote connection monitor unit 62, it outputs the received release request and the identification information of the virtual machine 4 under the controlled state to the virtual machine monitor 5.

The information processing device 1 has a virtual machine 4 and a virtual machine monitor 5. The virtual machine 4 has a guest OS 40 and a remote control server 41. The guest OS 40 controls the virtual machine 4. The remote control server 41 receives the remote control over the virtual machine 4 from the control terminal 2, and controls the guest OS 40 in accordance with the commands from the received remote control. The remote control server 41 outputs the displayed screen information to the control terminal 2. The remote control server 41 is one of the functions of the virtualized CPU 10. The virtualized CPU 10 follows the guest OS 40 or other application software.

The virtual machine monitor 5 has a virtual machine control receiving unit 517 in addition to the functions that the virtual machine monitor 5 has in Embodiment 1.

Since the device management table 51, the device release unit 53, the authentication unit 54, the device processing sorting unit 55, and the device emulator 56 are the same as those in Embodiment 1, the corresponding components are provided with the same reference codes and detailed explanations are omitted.

The device connection check unit 52 receives a request for releasing the device 3 and the identification information of the virtual machine 4 from the connection broker 6. The device connection check unit 52 extracts the identification information of the device 3 corresponding to the virtual machine 4 from the device management table 51. When the identification information of the device 3 exists in the device management table 51, the request for releasing the device 3, the identification information of the device 3, and the identification information of the virtual machine 4 are output to the device release unit 53.

The virtual machine control receiving unit 517 receives the start request and the user ID from the connection broker 6. The virtual machine control receiving unit 517 accesses the virtual machine management table (not illustrated) and extracts the identification information of the virtual machine 4 corresponding to the user ID. The virtual machine control receiving unit 517, when the virtual machine 4 corresponding to the user ID is not activated, outputs the start request and the identification information of the virtual machine 4 to the virtual machine activation unit 50. The virtual machine control receiving unit 517 transmits the address of the virtual machine 4 to the remote connection controller unit 21 of the control terminal 2 through the connection broker 6.

The virtual machine activation unit 50 receives the start request and the identification information of the virtual machine 4 from the virtual machine control receiving unit 517. The virtual machine activation unit 50 activates the virtual machine 4 corresponding to the received identification information of the virtual machine 4.

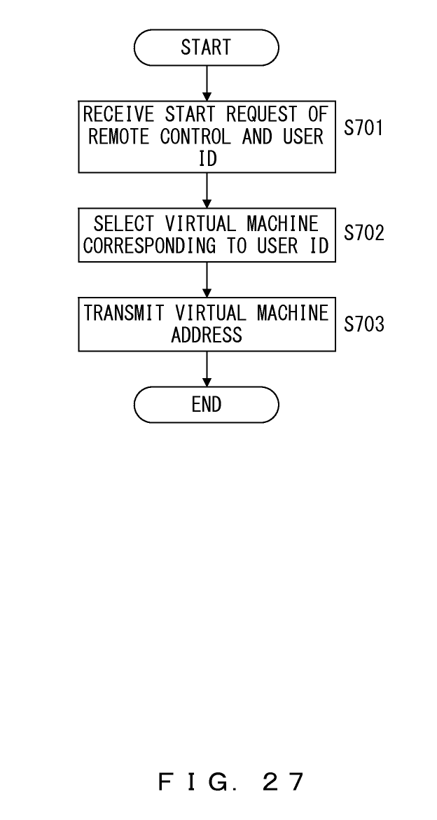

The CPU 10 of the information processing device 1 executes the following processing by fulfilling the function of the virtual machine monitor 5. FIG. 27 is a flowchart illustrating the procedures of the remote control processing executed by the information processing device 1 in Embodiment 6.

The virtual machine monitor 5 receives the start request for the remote control and the user ID from the control terminal 2 through the connection broker 6 (S701). The virtual machine monitor 5 accesses the virtual machine management table, and selects and activates the virtual machine 4 corresponding to the received user ID (S702). The virtual machine monitor 5 transmits the address of the selected virtual machine 4 to the control terminal 2 through the connection broker 6 (S703). The virtual machine monitor 5 terminates the processing. It should be noted that the virtual machine 4, when it is not activated at a point in time at which the connection request is received from the control terminal 2, may be activated and stopped at a point in time at which the remote control is terminated, or the virtual machine 4 may be left activated all the time.

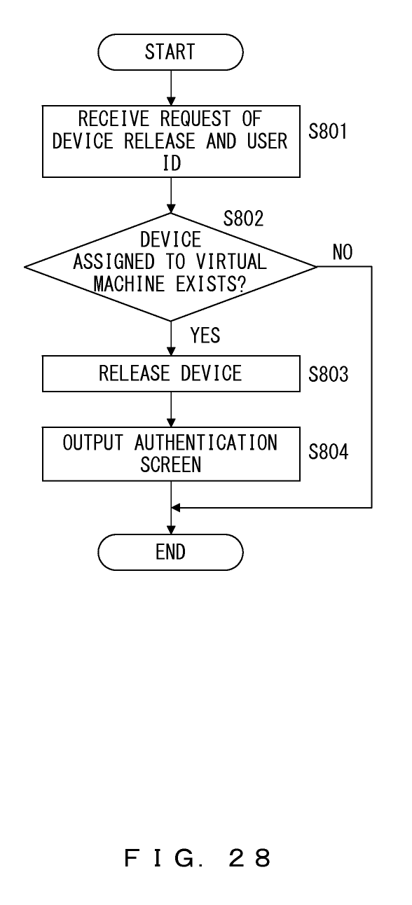

FIG. 28 is a flowchart illustrating the procedures of the device release processing executed by the information processing device 1 in Embodiment 6. The virtual machine monitor 5 receives a request for releasing the device 3 and a user ID from the connection broker 6 (S801). The virtual machine monitor 5 accesses the device management table 51, and determines whether the device 3 assigned to the received virtual machine 4 exists or not (S802). When the virtual machine monitor 5 determines that the assigned device 3 does not exist (NO in S802), it terminates the processing.

On the other hand, when the virtual machine monitor 5 determines that the assigned device 3 does exist (YES in S802), it releases the device 3 from the virtual machine 4 (S803). The virtual machine monitor 5 outputs the authentication screen to the released device 3 (output equipment) (S804). The virtual machine monitor 5 terminates the processing. The virtual machine monitor 5 waits until an input of the authentication information.

As described above, when the remote control over the virtual machine 4 connected with a device 3 starts, the disclosed virtual computer system releases the device 3 from the virtual machine 4. The released device 3 can be assigned to another virtual machine 4. As a result, more virtual machines 4 can be controlled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A virtual computer system, comprising:
a central unit to logically divide a physical resource and to cause the divided resources to operate as a plurality of virtual computers; and
a plurality of terminal devices connectable to the central unit through a communication line,
wherein each of the virtual computers includes a receiving unit to receive a remote control of the virtual computer itself from any one of the terminal devices,
wherein the central device includes:
an interface connecting to a plurality of input/output equipment;
an assigning unit to assign the connected input/output equipment to each of the virtual computers; and
a release unit to release the controlled computer from either the input/output equipment or the remote control when any one of the virtual computers is assigned input/output equipment and becomes a controlled computer controlled by the remote control, and
wherein the released input/output equipment can be assigned to another virtual computer different from the controlled computer.

2. The virtual computer system of claim 1, wherein
the release unit releases the input/output equipment when the virtual computer assigned the input/output equipment becomes a controlled computer.

3. The virtual computer system of claim 2,
wherein the virtual computer further includes
a detection unit to detect that the virtual computer itself has become a controlled computer; and
when the detection unit detects that the virtual computer itself has become the controlled computer, an output unit to request the release unit to release the input/output equipment from the virtual computer, and
wherein the release unit releases the input/output equipment from the controlled computer that requested the release.

4. The virtual computer system of claim 3, wherein
when the detection unit detects that the virtual computer itself has become the controlled computer, the virtual computer further includes a unit to output permission information questioning whether the release of the input/output equipment is permitted or not, and
wherein the output unit requests to release the input/output equipment in accordance with the received permission information.

5. The virtual computer system of claim 2, further comprising a detection device to detect any one of the virtual computers becoming a controlled computer,
wherein the detection device includes transmission means to request the central device to release the input/output equipment from the controlled computer when the detection device detects that one of the virtual computers becomes the controlled computer, and
wherein the release unit releases the input/output equipment from the controlled computer for which the request was made to release the input/output equipment.

6. The virtual computer system of claim 2,
wherein the central device further includes a storage unit to store a virtual computer to be assigned subsequently as being release-waiting when there is no assignable input/output equipment, and
wherein the release unit releases the input/output equipment from the controlled computer when there is a release-waiting virtual computer.

7. The virtual computer system of claim 6, wherein
the central device further includes a unit to report the release to the release-waiting virtual computer, when the release unit releases the input/output equipment from the controlled computer.

8. The virtual computer system of claim 2, wherein the assigning unit, when any one of the virtual computers requests an assignment of input/output equipment, assigns assignable input/output equipment to the virtual computer that requested the assignment.

9. The virtual computer system of claim 8, wherein the assigning unit assigns input/output equipment in an order of requests for assignment.

10. The virtual computer system of claim 8, wherein the assigning unit assigns input/output equipment in an order of prescribed priority.

11. The virtual computer system of claim 2, wherein the
assigning unit further comprises
a unit to generate virtual resources by virtualizing the input/output equipment; and
a unit to assign the generated virtual resource instead of input/output equipment to a controlled computer,
wherein the release unit releases input/output equipment from the controlled computer by assigning the generated virtual resource.

12. The virtual computer system of claim 1, wherein the release unit releases a remote control from the controlled computer when the assigning unit assigns input/output equipment to a controlled computer.

13. An information processing device to logically divide a physical resource and to cause the divided resources to operate as a plurality of virtual computers, comprising:
a receiving unit in which each of the virtual computers receives a remote control from an external device connected through a communication line;
an interface connecting to a plurality of input/output equipment;
an assigning unit to assign the connected input/output equipment to each of the virtual computers; and
a release unit to release the controlled computer from either the input/output equipment or the remote control when any one of the virtual computers is assigned input/output equipment and becomes a controlled computer controlled by the remote control.

14. The information processing device of claim 13 further comprising a unit to receive from the external device a request for releasing input/output equipment from the controlled computer,
wherein the release unit releases input/output equipment from the release-requested controlled computer.

15. A non-transitory computer-readable storage medium storing a computer program causing a computer to divide a physical resource and causing the divided resources to operate as a plurality of virtual computers, comprising:
causing each of the virtual machines to receive a remote control of an external device;
detecting each of a plurality of pieces of input/output equipment connected to each of the virtual computers;
assigning the detected input/output equipment to each of the virtual computers; and
releasing, when any one of the virtual computers is assigned input/output equipment and becomes a controlled computer controlled by the remote control, the controlled computer from either the input/output equipment or the remote control.

16. The storage medium of claim 15, wherein the releasing step, when receiving a request for releasing the controlled computer from input/output equipment, releases the release-requested controlled computer from the input/output equipment.

17. A connection control method of a virtual computer used in a virtual system having a central unit to logically divide a physical resource and to cause the divided resources to operate as a plurality of virtual computers and a plurality of terminal devices connectable to the central unit through a communication line, comprising
associating the virtual computer with input/output equipment or the terminal device connected to the central device requesting use of the virtual computer and storing the virtual computer associated with input/output equipment or the terminal device based on a use request to the virtual computers;
checking whether input/output equipment or a terminal device connected to the central device associated and stored with the virtual computer exists or not when the use request of the virtual computer is received; and
releasing, when input/output equipment or a terminal device connected to the central device associated and stored with the virtual computer exists, a connection between the virtual computer and the input/output equipment or the terminal device connected to the central device associated and stored with the checked virtual computer.
